(19) United States
(12) Patent Application Publication
(10) Pub. No.: US 2026/0287371 A1
(43) Pub. Date: Sep. 24, 2026

(54) SYSTEM

(71) Applicant: SoftBank Group Corp., Tokyo (JP)

(72) Inventor: Atsuko MURAKAMI, Tokyo (JP)

(73) Assignee: SoftBank Group Corp., Tokyo (JP)

(21) Appl. No.: 19/560,285

(22) Filed: Mar. 9, 2026

(30) Foreign Application Priority Data
Mar. 19, 2025 (JP) 2025-044517

(51) Int. Cl. G01C 21/34; G06F 16/29; G06N 3/0475

(52) U.S. Cl. CPC G01C 21/3461; G06F 16/29; G06N 3/0475

(57) ABSTRACT

A system includes a processor that is configured to collect information, analyze the collected information, acquire map information, display a specific location on the map information, acquire visual information of the specific location, investigate a specific time period associated with the specific location, input a prompt to a generative artificial intelligence model, and acquire information from the generative artificial intelligence model.

### CROSS-REFERENCE TO RELATED APPLICATION

This application is based on and claims priority under 35 USC 119 from Japanese Patent Application No. 2025-044517 filed on Mar. 19, 2025, the disclosure of which is incorporated by reference herein.

### BACKGROUND

### Technical Field

The present disclosure relates to a system.

### Related Art

Japanese Patent Application Laid-Open (JP-A) No. 2022-180282 discloses a persona chatbot control method executed by at least one processor. The method includes steps of: receiving a user utterance, adding the user utterance to a prompt including a description of a chatbot character and an associated instruction sentence, encoding the prompt, and inputting the encoded prompt to a language model to generate a chatbot utterance responding to the user utterance.

Recently, various types of crime and incidents threatening personal safety have tended to concentrate at particular locations and during particular time periods. However, conventional safety information systems typically present only static crime statistics or simple incident lists, and therefore fail to dynamically correlate location-based information, time-based information, map information, visual information such as images or videos, and information generated by advanced artificial intelligence models. As a result, it is difficult for users, such as residents, students, parents, and local governments, to intuitively understand which specific places and specific time periods involve higher risks, to obtain detailed contextual information about those places, and to derive practical guidance, such as safe routes and effective regional countermeasures. There is therefore a need for a system that can comprehensively collect and analyze heterogeneous safety-related information, visualize specific locations on a map together with their associated temporal and visual context, and cooperate with a generative artificial intelligence model so as to provide enhanced safety support, including route proposals and clarification of regional measures.

### SUMMARY

In order to solve the above-described problem, the present invention provides a system comprising a processor, wherein the processor is configured to collect information, analyze the collected information, acquire map information, display a specific location on the map information, acquire visual information of the specific location, investigate a specific time period associated with the specific location, input a prompt to a generative artificial intelligence model, and acquire information from the generative artificial intelligence model. In one aspect, the processor is further configured to propose a safe route based on the specific location, for example by evaluating route candidates in view of information about the specific location displayed on the map and information obtained from the generative artificial intelligence model. In another aspect, the processor is further configured to clarify countermeasures to be implemented in a region based on the specific location, for example by utilizing the analyzed information, the visual information, and the information acquired from the generative artificial intelligence model to identify and present regional safety measures that are suitable for the characteristics of the specific location and time period.

The term “system” refers to an arrangement of one or more hardware and software components that operate together to perform the processing defined in the claims.

The term “processor” refers to one or more hardware processing units, such as a central processing unit (CPU), a graphics processing unit (GPU), a microcontroller, or any combination thereof, that executes instructions to perform the claimed functions.

The term “information” refers to data of any type relevant to safety or risk analysis, including but not limited to crime statistics, incident reports, social media data, sensor data, geographic data, and user-provided data.

The term “collect information” refers to acquiring information from one or more sources, such as external databases, network services, sensors, user inputs, or storage devices, and storing the information in a memory accessible by the processor.

The term “analyze the collected information” refers to processing the collected information using one or more techniques, such as statistical analysis, pattern recognition, clustering, classification, or rule-based processing, to derive correlations, trends, risk indicators, or other derived data.

The term “map information” refers to digital geographic data representing at least part of a real-world area, including but not limited to road networks, land parcels, buildings, landmarks, or other spatial features, which can be displayed on a graphical user interface.

The term “acquire map information” refers to obtaining map information from a map database, a map service, or another storage or network source, and preparing the map information for display or further processing.

The term “specific location” refers to a particular geographic point or region within the map information, which is identified by coordinates, an address, an area designation, or any other spatial identifier.

The term “display a specific location on the map information” refers to presenting, on a display device, a representation of the specific location overlaid on or integrated with the map information, such that a user can visually recognize the position or extent of the specific location.

The term “visual information” refers to image data or video data, including but not limited to photographs, street-view images, aerial images, or recorded video sequences, that visually depict at least a part of the specific location.

The term “acquire visual information of the specific location” refers to obtaining visual information corresponding to the specific location from one or more sources, such as a street-view service, an image or video database, a camera device, or a drone imaging system.

The term “specific time period” refers to a defined temporal range associated with the specific location, such as a particular time of day, day of the week, date range, or recurrent time band during which events of interest occur.

The term “investigate a specific time period” refers to determining, analyzing, or identifying one or more time periods that are relevant to the specific location, for example by examining temporal patterns in the collected information to find time ranges exhibiting notable events or risks.

The term “generative artificial intelligence model” refers to a machine learning model configured to generate text, images, or other content in response to input data, including but not limited to large language models, image generation models, or multimodal generative models.

The term “input a prompt to a generative artificial intelligence model” refers to providing, to the generative artificial intelligence model, input data in the form of text, structured data, or other encodings that specify a request, question, instruction, or context for generating output.

The term “acquire information from the generative artificial intelligence model” refers to receiving output data generated by the generative artificial intelligence model in response to the prompt, such as explanatory text, summaries, recommendations, or other generated content, and making the output available for further processing or display.

The term “safe route” refers to a path connecting at least a start location and a destination, which is evaluated or selected in view of safety-related criteria so as to reduce exposure to locations or time periods associated with higher risk.

The term “propose a safe route based on the specific location” refers to generating or selecting at least one route that takes into account the specific location and related information, and outputting the route as a candidate or recommended path that avoids or mitigates risks associated with the specific location.

The term “countermeasures to be implemented in a region” refers to actions, plans, or measures intended to improve safety or reduce risks in a geographic area, including but not limited to installing equipment, increasing patrols, modifying infrastructure, conducting public awareness activities, or changing administrative policies.

The term “clarify countermeasures to be implemented in a region based on the specific location” refers to identifying, determining, or presenting one or more countermeasures that are suitable for a region in view of information related to the specific location, and expressing such countermeasures in a form that can be understood and utilized by users or authorities.

### BRIEF DESCRIPTION OF THE DRAWINGS

Exemplary embodiments of the present disclosure will be described in detail based on the following figures, wherein:

FIG. 1 is a schematic diagram illustrating an example of a configuration of a data processing system according to a first exemplary embodiment;

FIG. 2 is a schematic diagram illustrating an example of relevant functions of a data processing device and a smart device according to the first exemplary embodiment;

FIG. 3 is a schematic diagram illustrating an example of a configuration of a data processing system according to a second exemplary embodiment;

FIG. 4 is a schematic diagram illustrating an example of relevant functions of a data processing device and smart glasses according to the second exemplary embodiment;

FIG. 5 is a schematic diagram illustrating an example of a configuration of a data processing system according to a third exemplary embodiment;

FIG. 6 is a schematic diagram illustrating an example of relevant functions of a data processing device and a headset-type terminal according to the third exemplary embodiment;

FIG. 7 is a schematic diagram illustrating an example of a configuration of a data processing system according to a fourth exemplary embodiment;

FIG. 8 is a schematic diagram illustrating an example of relevant functions of a data processing device and a robot according to the fourth exemplary embodiment;

FIG. 9 illustrates an emotion map mapping plural emotions;

FIG. 10 illustrates an emotion map mapping plural emotions;

FIG. 11 is a sequence diagram showing the flow of data processing system processing in Example 1;

FIG. 12 is a sequence diagram showing the flow of data processing system processing in Application Example 1;

FIG. 13 is a sequence diagram showing the flow of data processing system processing in Example 2; and

FIG. 14 is a sequence diagram showing the flow of data processing system processing in Application Example 2.

### DETAILED DESCRIPTION

Description follows regarding an example of exemplary embodiments of a system according to technology disclosed herein, with reference to the appended drawings.

First, explanation follows regarding terminology employed in the following description.

In the following exemplary embodiments, a reference-numeral-appended processor (hereinafter simply referred to as “processor”) may be implemented by a single computation unit, and may be implemented by a combination of plural computation units. The processor may be implemented by a single type of computation unit, or may be implemented by a combination of plural types of computation units. Examples of computation unit include a central processing unit (CPU), a graphics processing unit (GPU), a general-purpose computing on graphics processing units (GPGPU), an accelerated processing unit (APU), and the like.

In the following exemplary embodiments, random access memory (RAM) appended with a reference numeral is memory temporarily stored with information, and is employed as working memory by a processor.

In the following exemplary embodiments, reference-numeral-appended storage is a single or plural non-volatile storage devices for storing various programs and various parameters and the like. Examples of non-volatile storage devices include flash memory (such as a solid state drive (SSD)), a magnetic disk (for example, a hard disk), magnetic tape, and the like.

In the following exemplary embodiments, a reference-numeral-appended communication interface (I/F) is an interface including a communication processor and an antenna or the like. The communication I/F has the role of communicating between plural computers. An example of a communication standard applied for the communication I/F is a wireless communication standard, such as a Fifth Generation Mobile Communication System (5G), Wi-Fi (registered trademark), Bluetooth (registered trademark), and the like.

In the following exemplary embodiments “A and/or B” has the same definition as “at least one out of A or B”. Namely, “A and/or B” may mean A alone, may mean B alone, or may mean a combination of A and B. Moreover, similar logic to “A and/or B” is applied when “and/or” is employed to link three or more items in the present specification.

### First Exemplary Embodiment

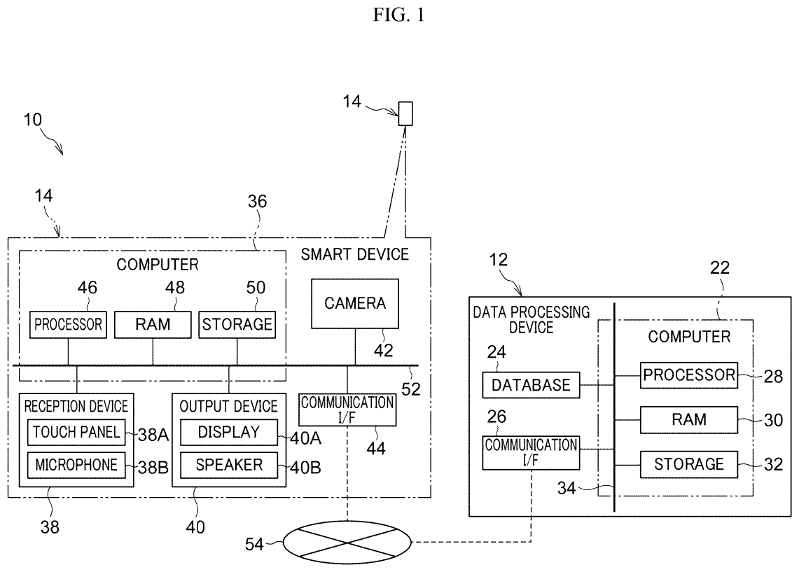

FIG. 1 illustrates an example of a configuration of a data processing system 10 according to a first exemplary embodiment.

As illustrated in FIG. 1, the data processing system 10 includes a data processing device 12 and a smart device 14. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart device 14 includes a computer 36, a reception device 38, an output device 40, a camera 42, and a communication I/F 44. The computer 36 includes a processor 46, RAM 48, and storage 50. The processor 46, the RAM 48, and the storage 50 are connected to a bus 52. The reception device 38, the output device 40, the camera 42, and the communication I/F 44 are also connected to the bus 52.

The reception device 38 includes a touch panel 38A, a microphone 38B, and the like for receiving user input. The touch panel 38A receives user input from contact of a pointer (for example, a pen, a finger, or the like) by detecting contact of the pointer. The microphone 38B receives spoken user input by detecting speech of the user. A control unit 46A in the processor 46 transmits data representing the user input received by the touch panel 38A and the microphone 38B to the data processing device 12. A specific processing unit 290 in the data processing device 12 acquires the data indicating the user input.

The output device 40 includes a display 40A, a speaker 40B, and the like for presenting data to a user 20 by outputting the data in an expression format perceivable by the user 20 (for example, audio and/or text). The display 40A displays visual information such as text, images, or the like under instruction from the processor 46. The speaker 40B outputs audio under instruction from the processor 46. The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like.

The communication I/F 44 is connected to the network 54. The communication I/F 44 and the communication I/F 26 perform the role of exchanging various information between the processor 46 and the processor 28 over the network 54.

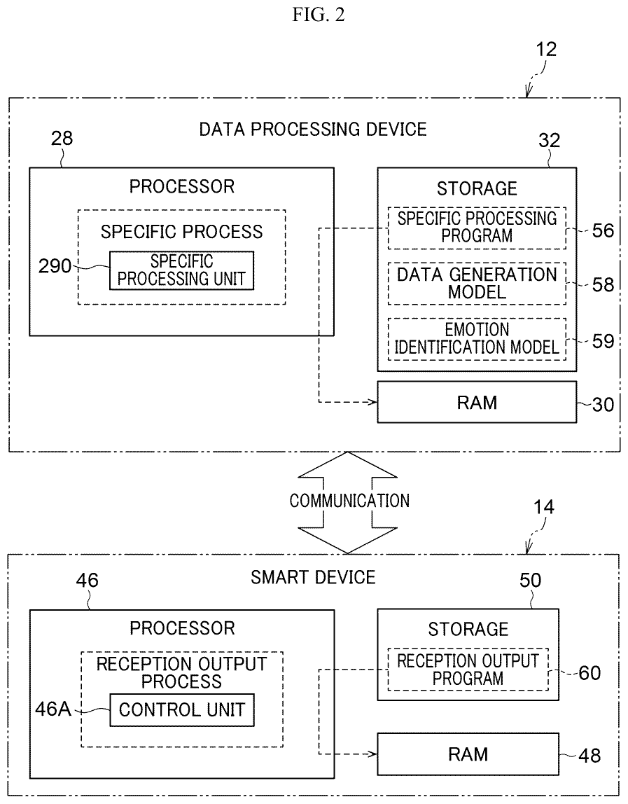

FIG. 2 illustrates an example of relevant functions of the data processing device 12 and the smart device 14.

As illustrated in FIG. 2, specific processing is performed by the processor 28 in the data processing device 12. A specific processing program 56 is stored in the storage 32. The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

A data generation model 58 and an emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart device 14. A reception and output program 60 is stored in the storage 50. The reception and output program 60 is employed by the data processing system 10 in combination with the specific processing program 56. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48. Note that a configuration may be adopted in which a similar data generation model and emotion identification model to the data generation model 58 and the emotion identification model 59 are included in the smart device 14, and these models are used to perform similar processing to the specific processing unit 290. The reception and output program is implemented by the processor 46 operating as the control unit 46A according to the reception and output program 60 executed in the RAM 48.

Note that devices other than the data processing device 12 may include the data generation model 58. For example, a server device (for example, a generation server) may include the data generation model 58. In such cases, the data processing device 12 performs communication with the server device including the data generation model 58 to obtain a processing result (prediction result or the like) obtained using the data generation model 58.

The data processing device 12 may be a server device, and may be a terminal device owned by the user (for example, a mobile phone, a robot, a home electrical appliance, or the like). Next, description follows regarding an example of processing by the data processing system 10 according to the first exemplary embodiment.

### Example 1

Description follows regarding a flow of the specific processing in an Example 1. The units of the system described below are implemented by the data processing device 12 and the smart device 14. The data processing device 12 is called a “server” and the smart device 14 is called a “terminal”.

Conventional computer-implemented crime analysis and mapping systems typically focus on displaying static incident counts or heatmaps over geographic regions. Such systems suffer from several technical limitations. First, they generally perform only simple aggregation over space or time and do not exploit unsupervised learning techniques on structured feature representations, which leads to poor discrimination of fine-grained spatio-temporal patterns and results in either over-cluttered or over-smoothed map visualizations. Second, conventional systems often treat time information as a mere filter rather than as a primary analytical dimension, so that dynamic changes in risk across time bands are not effectively captured, stored, or exposed to downstream components in a machine-usable form. Third, existing map-based interfaces typically present risk indicators as static overlays and do not integrate them with interactive, street-level or aerial imagery in a tightly coupled manner; as a result, the user interface subsystem cannot contextually adjust map rendering based on underlying risk indices while preserving responsiveness and clarity.

Further, traditional systems that provide text-based advice about safety or route selection are generally rule-based or rely on static templates. They do not integrate a generative information processing model, such as a generative AI model, in a way that is deeply coupled with structured spatio-temporal risk data and map rendering states. When generative models are used in isolation as external services, the models operate purely on textual prompts, without access to structured representations of high-risk regions, high-risk time bands, or route candidates calculated by the system. Consequently, responses from such generative models may not be aligned with the actual computed risk landscape, may be difficult to project back onto the map view, and may not support consistent, synchronized updates of visual elements.

Additionally, there is no unified computational pipeline in conventional systems that (i) acquires heterogeneous event information from external information sources, (ii) structures and normalizes the information into tabular form suitable for machine learning, (iii) applies clustering based on numerical features derived from both spatial and temporal attributes, (iv) computes quantitative index values for high-risk regions, and (v) exposes these index values as control signals for interactive visualization and for conditioning a generative information processing model. Without such an integrated architecture, systems encounter technical problems including increased latency due to ad hoc data transformations, inability to reuse analytical results across modules, and inconsistent risk semantics between the analytics engine, the visualization engine, and a generative AI component.

Accordingly, there is a need for an improved computer-implemented system and method that: (1) automatically converts raw event information into normalized tabular data and numerical features; (2) performs unsupervised clustering to identify high-risk regions and high-risk time bands with associated index values; (3) tightly integrates these analytical outputs with a geographic visualization engine capable of interactive map display and on-demand retrieval of ground or aerial imagery; and (4) couples structured spatio-temporal risk data with a generative information processing model through a controlled prompt and context interface, such that the model's natural-language responses can be reliably mapped back onto the geographic display and used to drive route highlighting and countermeasure visualization. The technical problem addressed by the present invention is to improve the functioning of a computer system for spatio-temporal risk analysis and map-based interaction by providing a unified processing architecture that enables more accurate, context-aware, and machine-actionable integration between data analytics, visualization, and generative AI-based explanation.

The specific processing by the specific processing unit 290 of the data processing device 12 in Example 1 is realized by the following means.

The present invention provides a server comprising a processor configured to acquire, via a communication network, event information associated with locations and times from at least one external information source and to structure the event information into tabular data with normalized time fields and corrected missing values, to convert type information and time information included in the tabular data into numerical features and to execute clustering processing based on a machine learning technique using the numerical features so as to extract high-risk regions and high-risk time bands and calculate index values for the high-risk regions, to obtain map images from a geographic information providing service on the basis of position information of the high-risk regions and to generate display data by assigning, to representations of the high-risk regions on the map images, visual attributes corresponding to the index values, to provide the display data to a client terminal so that the client terminal can interactively display on the map images the high-risk regions and, in response to a position designation operation from a user, request and present ground images or aerial images corresponding to coordinates of a designated high-risk region, to aggregate event occurrence frequencies for each time band on the basis of the tabular data and the clustering results, to specify, as the high-risk time bands, time bands in which the event occurrence frequencies exceed a predetermined threshold and to manage associations between the high-risk regions and the high-risk time bands, to accept from the client terminal a prompt sentence in a natural language including a condition input by the user and to generate query data by combining the prompt sentence with structured data relating to the high-risk regions, the high-risk time bands, and route candidates calculated so as to avoid the high-risk regions, to input the query data to a generative information processing model and obtain response information in a natural language output from the generative information processing model, and to associate descriptions relating to regions, routes, and countermeasures included in the response information with the high-risk regions and to transmit control information for updating map display states to the client terminal. This enables a computer system to perform an integrated spatio-temporal risk analysis and visualization workflow in which data acquisition, feature generation, clustering, index computation, interactive map rendering, on-demand retrieval of visual imagery, and generative AI-based explanation are coherently orchestrated, thereby improving the system's ability to compute and maintain consistent risk semantics across analytical, visualization, and natural-language interaction components, to generate safer route suggestions and region-specific countermeasures based on quantitative indices, and to dynamically adapt map displays in response to user prompts and generative model outputs.

The term “event information” refers to digitally represented data records that each indicate an occurrence of an event and include at least information associating the event with a geographic location and a time, and optionally one or more attributes such as event type, severity, or source text.

The term “external information source” refers to a data providing system accessible via a communication network, such as a database service or application programming interface, that supplies event information or related contextual data to the server.

The term “tabular data” refers to structured data organized into rows and columns, where each row corresponds to an event and each column corresponds to a field such as time, location, or event attribute, the data being suitable for processing by numerical analysis or machine learning algorithms.

The term “missing-value correction” refers to a processing operation that detects absent, null, or invalid values in the tabular data and replaces such values with substituted values derived from rules, defaults, or statistical estimation.

The term “time normalization” refers to a processing operation that converts various time expressions related to events, such as local timestamps or textual time fields, into a unified representation, including at least a standardized time zone and normalized subfields such as date, hour, or day-of-week.

The term “type information” refers to categorical information describing a classification of an event, such as a crime category, incident class, or other event label, which may be used as a feature in machine learning.

The term “numerical features” refers to numerical values or vectors derived from the tabular data, including at least encodings of type information, time information, and spatial information, that are used as inputs to a machine learning algorithm.

The term “clustering processing” refers to an unsupervised machine learning operation that groups events based on similarity of numerical features so that events in the same group are more similar to each other than to events in different groups.

The term “high-risk region” refers to a geographic area identified through clustering processing and associated statistical analysis as having an event occurrence tendency greater than a predetermined threshold, and to which an index value representing risk is assigned.

The term “high-risk time band” refers to a continuous or discrete range of time, such as a set of hours or specified periods, for which aggregated event occurrence frequency exceeds a predetermined threshold in association with one or more high-risk regions.

The term “index value” refers to a numerical or categorical indicator computed for each high-risk region based on at least one factor such as event frequency, severity, or density, and used to quantify and compare relative risk levels between different regions.

The term “geographic information providing service” refers to a network-accessible service that supplies map images or other geographic representation data in response to requests including position information or geographic parameters.

The term “map image” refers to a graphical representation of a geographic area, including at least a coordinate system or projection, suitable for displaying positions of events or regions on a two-dimensional or pseudo-three-dimensional visualization.

The term “display data” refers to data structures generated for use by a client terminal to render a visual representation on a user interface, including at least map image references, coordinates of high-risk regions, and visual attributes assigned according to index values.

The term “visual attribute” refers to a display property, such as color, size, opacity, shape, or line style, applied to a graphical element representing a region, route, or other object on the map image, and used to indicate at least a risk level or category.

The term “client terminal” refers to an information processing device, such as a personal computer, mobile terminal, or other user-operated device, that communicates with the server, receives display data, and presents interactive visual content to a user.

The term “position designation operation” refers to a user interaction performed on a user interface, such as a click, tap, or selection on a map image, that designates a geographic position, region, or object displayed on the map image.

The term “ground image” refers to a visual image or sequence of images captured at or near ground level, such as a street-level photograph or panoramic view, corresponding to a particular geographic position.

The term “aerial image” refers to a visual image or sequence of images captured from an elevated perspective, such as from an aircraft, unmanned aerial vehicle, or satellite, corresponding to a particular geographic area.

The term “visual information providing service” refers to a network-accessible service that supplies ground images or aerial images in response to requests containing coordinate information or area designations.

The term “event occurrence frequency” refers to a numerical measure representing how many events occur within a specified time band and/or geographic region, calculated by aggregating event information in the tabular data.

The term “association” refers to a stored relationship between data items, such as a mapping between a high-risk region and one or more high-risk time bands, or between a textual description and a geographic entity.

The term “prompt sentence” refers to a sequence of natural-language text characters input by a user, including at least one condition or query, and intended to elicit a response from a generative information processing model.

The term “structured data” refers to data organized in a predefined format, such as key-value pairs, tables, or hierarchical objects, including at least representations of high-risk regions, high-risk time bands, and route candidates suitable for machine processing.

The term “query data” refers to a data structure generated by combining a prompt sentence with structured data, the data structure being formatted for input to a generative information processing model.

The term “generative information processing model” refers to a trained computational model, such as a generative AI model, configured to generate natural-language response information based on at least a prompt sentence and associated context data.

The term “response information” refers to natural-language text or equivalent structured content generated by the generative information processing model in response to query data and representing explanations, recommendations, or descriptions.

The term “route candidate” refers to a path or sequence of geographic segments calculated between a departure point and a destination point by a route search technique and considered for selection as a user route.

The term “route search technique” refers to an algorithmic method, such as a graph search or pathfinding algorithm, executed to compute one or more route candidates between two or more geographic points under specified constraints.

The term “countermeasure item candidate” refers to a proposal or action item associated with reducing risk or addressing events in a high-risk region and/or high-risk time band, generated together with a priority for evaluation or selection.

The term “map display state” refers to a configuration of visual elements on a map image, including displayed regions, routes, markers, visual attributes, and user interface overlays at a given time.

The term “control information for updating map display states” refers to instructions or parameters transmitted from the server to the client terminal that specify how the client terminal should modify the current map display state, such as emphasizing certain routes, highlighting particular regions, or displaying recommended countermeasures.

In one embodiment, the system includes a server, at least one terminal, and at least one storage device connected via a communication network. The server comprises at least one processor and a memory storing program instructions. The processor executes the program instructions to perform event acquisition, feature generation, clustering-based risk analysis, map-related data processing, generative AI interaction, and control of visual presentation on the terminal. The terminal comprises a display, an input interface, and a communication interface, and executes browser software or application software to render interactive maps, images, and text based on data received from the server.

The server uses general-purpose computing hardware, such as a multi-core processor conforming to an instruction set architecture, a volatile memory, and a non-volatile storage device. The server runs an operating system and middleware supporting a runtime environment for a programming language. The server, in one example, executes a program written in a high-level language that invokes libraries corresponding to an HTTP communication library, a data analysis library that provides a tabular data structure and numerical operations, and a machine learning library that provides clustering algorithms, encoders, and numerical utilities. The server also accesses an external geographic information service via an HTTP interface conforming to a map imagery application programming interface, and accesses an external visual information service providing ground-level and aerial imagery via an HTTP interface conforming to a street-level or aerial imagery application programming interface.

The server stores event information in a data structure corresponding to a tabular matrix, such as a data frame object provided by a data analysis library. The server represents each event as a row and represents fields such as timestamp, latitude, longitude, event category, severity score, and textual description as columns. The server normalizes timestamps by converting all timestamps to a unified time zone and then decomposing them into derived columns, such as a date column, an hour_of_day column, and a day_of_week column represented, for example, as an integer or categorical code. The server performs missing-value correction by executing a routine that scans columns for null or invalid entries and replaces them with estimated values computed from statistical measures (for example, mean or median of nearby entries) or rule-based defaults (for example, discarding events with completely missing location fields but retaining events with partial missing attributes). The server thus improves data quality in a consistent, machine-readable form.

The server converts categorical type information, such as event category and day_of_week, into numerical features using encoding techniques supplied by the machine learning library.

The server uses, for example, a one-hot encoder to create binary indicator columns for each category, ensuring that each event is represented by a fixed-dimensional numerical feature vector. The server also uses continuous attributes, such as latitude, longitude, and hour_of_day, and rescales them using a normalization or standardization method so that each dimension has comparable magnitude. The server combines these encoded and normalized values into a numerical matrix that serves as input to a clustering algorithm.

The server executes a clustering algorithm from the machine learning library, such as a centroid-based clustering algorithm or a density-based clustering algorithm. The server sets parameters including a number of clusters or a distance threshold (epsilon) and a minimum number of samples per cluster, and supplies the numerical matrix as input. The algorithm then iteratively computes, for example, cluster centroids and assigns each event to the nearest centroid, or identifies dense regions in feature space. The server receives, as output, a cluster label for each event and centroid coordinates in feature space. The server then aggregates the original geographic coordinates and risk-relevant attributes for each cluster to compute a high-risk region. Specifically, the server computes, for each cluster, at least a geographic centroid (for example, mean latitude and longitude of events in the cluster), a total event count, and an aggregate severity measure. The server then computes an index value for each region using a function of event count, severity, and possibly temporal concentration, e.g., a weighted sum or normalized score. This index value is used as a quantitative risk indicator.

The server aggregates event occurrence frequencies for each time band. The server, for example, defines time bands such as hourly intervals or composite intervals such as “weekdays 18:00-24:00” and “weekends 20:00-02:00”. The server performs grouping operations on the tabular data using a composite key consisting of region identifier and time band identifier, and counts the number of events in each group. The server compares the obtained frequencies with a threshold value that may be dynamically determined (for example, based on percentile values) and designates time bands whose frequencies exceed the threshold as high-risk time bands. The server stores these associations in a dedicated data structure, such as a mapping from region identifier to a list of high-risk time bands, and uses this mapping both for later visualization and for conditioning the generative AI model.

The server requests map images from a geographic information providing service. The server uses the geographic centroids of high-risk regions as inputs and constructs HTTP requests to the map imagery API including parameters such as latitude, longitude, zoom level, and map type. The server receives responses in the form of tile URLs or vector map descriptors. The server constructs display data that includes, for each high-risk region, the region centroid, a shape or radius representing a coverage area, and a visual attribute derived from the index value, such as a color intensity or marker size. The server then sends this display data, along with map configuration parameters, to the terminal via an application programming interface.

By centralizing map data generation and visual attribute assignment on the server, the system reduces redundant computations on the terminal and ensures that risk semantics are consistent across different client devices.

The terminal executes browser software or application software to interpret the display data.

The terminal obtains map tiles from a configured map tile provider and composes them into a base map. The terminal draws graphical elements, such as circles, polygons, or markers, at the positions of the high-risk regions using a client-side library configured to handle map rendering and user input. The terminal sets visual attributes, including color gradient and opacity, as instructed by the display data. In this way, the terminal displays, on its display, high-risk regions with varying emphasis corresponding to risk levels, and allows the user to pan and zoom smoothly. The terminal stores event handlers that detect a position designation operation by the user, such as a click or tap on a region. Upon detecting such an operation, the terminal sends a request containing the coordinate and region identifier to the server.

The server receives the region identifier and coordinate from the terminal and, in response, constructs a request to a visual information providing service that supplies ground images or aerial images for the specified coordinate. The server includes parameters such as latitude, longitude, orientation, and field-of-view in the request. The service returns a ground image or aerial image data or an access URL. The server then forwards this information to the terminal. The terminal embeds the image in a designated viewing area, such as a panel adjacent to the map, and synchronizes the visual imagery with the map view. The terminal may, for example, center the map on the selected region when the user opens the image. This coupling of the map display and external imagery allows a user to visually confirm physical conditions, such as lighting or obstructions, and thereby links the risk computation to real-world environmental characteristics.

The server also performs route candidate computation. The server retrieves a street or path network representation, such as a graph whose nodes represent intersections and whose edges represent road segments, from a geographic data store. The server assigns weights to edges based on both base travel cost (such as distance or estimated travel time) and risk-related penalties derived from overlap with high-risk regions and high-risk time bands. The server executes a pathfinding algorithm, such as Dijkstra's algorithm or an A* search, using a departure point and a destination point as input. The server outputs one or more route candidates with associated cumulative cost values that reflect both safety and efficiency. This route computation procedure differs from simple shortest-path calculation because the server dynamically integrates clustering-derived risk indices and temporal risk profiles into edge weights, thereby directly influencing the exploration order and cost function within the pathfinding algorithm. As a result, the server can systematically avoid high-risk regions while maintaining acceptable travel length, which is a non-trivial modification of traditional routing algorithms.

The server integrates a generative AI model as a generative information processing model. In one example, the generative AI model is a transformer-based neural network trained on a large corpus of natural-language text. The generative AI model comprises an embedding layer that maps tokens to vector representations, multiple self-attention layers that compute attention weights between tokens, feedforward layers that transform intermediate representations, and a final output layer that generates probability distributions over the token vocabulary. The server stores, in a model configuration, hyperparameters such as number of layers, number of attention heads, embedding dimension, and context window length. The generative AI model is trained using a language modeling objective, such as minimizing cross-entropy loss between predicted tokens and actual tokens, with optimization performed using gradient-based updates such as stochastic gradient descent variants. The model learns internal parameters (weights and biases) that encode statistical relationships in language and, in an optional further training stage, domain-specific spatio-temporal descriptions and safety guidelines. The server does not simply invoke the generative AI model as an external assistant; instead, the server constructs a structured query that embeds the system's analytical results into the model's context.

The server receives a prompt sentence from the terminal. The user, for example, inputs prompt sentences such as:

“Please describe the crime patterns around my current location on weekend nights and suggest a safer walking route home.”

“Based on current analysis, which streets near my position should I avoid after 9 PM?” “Compare the safety of Route A and Route B after 10 PM and recommend which one I should take.”

“Summarize the typical types of crimes that happen within 500 meters of this point and indicate the highest-risk hours.”

The terminal transmits the prompt sentence to the server, together with metadata such as the current region, selected time band, and identifiers of relevant route candidates. The server constructs query data by placing the prompt sentence into a text field and encoding structured data, such as lists of high-risk regions, their index values, time band information, and route candidate attributes, into a machine-readable context representation. The server formats this context as a sequence of name-value pairs or as a structured description appended to or interleaved with the prompt sentence. The server then forwards this combined query to the generative AI model.

The generative AI model processes the combined query by embedding both the text of the prompt sentence and the structured context into token sequences, computing self-attention across tokens, and generating an output sequence that represents response information in natural language. As the context explicitly encodes numeric index values, names of high-risk regions, and attributes of route candidates, the model's attention mechanism can relate specific textual tokens (such as “this street” or “Route A”) to underlying structured elements. This design allows the model to generate explanations whose content is aligned with the system's computed risk structure. The server then parses the output, detects references to particular regions or routes (for example, by matching labels or identifiers), and constructs control information for updating map display states. The server may, for example, interpret the model's statement “Route B is safer” as an instruction to highlight Route B in a specific color while dimming Route A. In this way, the generative AI model is not merely providing narrative advice; it is driven by and feeds back into the system's internal data structures.

The server thereby improves the functioning of the computer system. By representing risk in numerical features and clustering-based groupings, the server reduces the dimensionality and redundancy of raw event data, which in turn reduces the size of data transmitted to the terminal and improves communication efficiency. By precomputing index values and high-risk time bands on the server, the system enables fast, on-the-fly filtering and rendering on the terminal without requiring expensive recomputation of analytics for each user interaction, which improves responsiveness and reduces computational load on client devices. By tightly coupling the generative AI model with structured risk data, the server prevents inconsistent or hallucinated risk descriptions and instead enforces a controlled mapping between computed risk and textual explanations, thus improving the accuracy and reliability of generative outputs in the context of the map-based interface.

The system also exhibits improved data management. The server maintains a modular architecture in which data acquisition, feature generation, clustering, time-band aggregation, map-data construction, route computation, and generative AI interaction are each handled by distinct modules with clearly defined data structures and interfaces. The server defines intermediate representations, such as a high-risk region object containing a region identifier, centroid, index value, and a list of associated time bands, and a route candidate object containing a route identifier, a list of nodes, total cost, and overlapping region identifiers. These intermediate representations support efficient reuse across multiple functions; for example, the same high-risk region object is used to render map symbols, to adjust route edge weights, and to produce descriptive text in generative outputs. This modular and reusable data flow reduces duplication of computation and memory usage, and ensures consistency of risk semantics across the system.

The server and terminal operate in concert to produce technical effects beyond simple automation of human tasks. A human operator, using conventional tools, might manually inspect static incident maps, read separate textual analyses, and mentally combine this information to decide on a safe route. In contrast, the system executes a series of machine-oriented transformations that exploit high-dimensional numerical representations, unsupervised learning, and transformer-based natural language generation. The server encodes spatio-temporal risks and integrates them into both the pathfinding algorithm and the generative AI model context. As a result, route computation is systematically optimized according to a multi-criteria cost function, and natural-language explanations are generated in a way that is structurally tied to these optimizations. This arrangement reduces human cognitive load, increases the speed at which routes and explanations can be generated and updated when new data arrives, and reduces error caused by inconsistent interpretation of risk information.

In an alternative embodiment, the server may use different clustering algorithms, such as hierarchical clustering or grid-based clustering, and may define index values using different formulae, such as a combination of kernel density estimates and temporal variability scores. In another embodiment, the server may use a different class of generative model, such as a recurrent neural network or a sequence-to-sequence architecture, trained with supervised fine-tuning on domain-specific question-answer pairs. In yet another embodiment, the system may run on a distributed architecture in which multiple servers handle different stages of the pipeline, such as one server for event acquisition and preprocessing, another for machine learning and clustering, and a third for generative AI interaction and map data orchestration.

The terminal may be implemented as a mobile application, a desktop application, or a web-based client using varying rendering libraries, but in each case the server maintains responsibilities for the core analytical and generative processes and provides structured control information to the terminal.

In summary, the server implements concrete data structures, algorithms, and model integration strategies that collectively improve computational efficiency, analytical accuracy, and visualization responsiveness. The terminal renders these results in an interactive form that allows the user to access high-risk region information, high-risk time bands, ground and aerial images, and generative AI explanations in a unified interface. The user therefore can understand and act upon complex spatio-temporal risk information, while the underlying computer system is technically improved through structured machine learning pipelines, optimized data flows, and integrated generative model control.

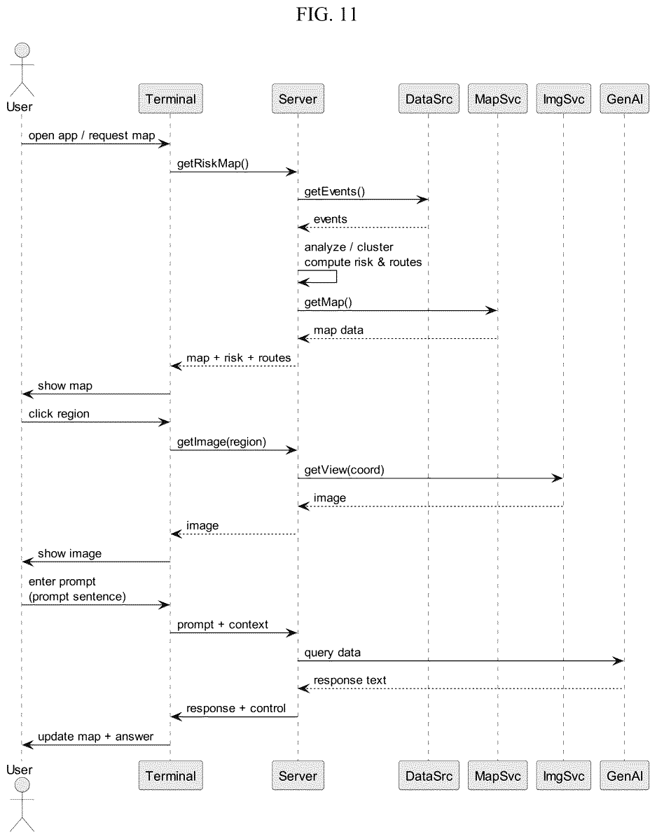

The following describes the processing flow using FIG. 11.

### Step 1:

The server acquires raw event information from external information sources.

The server receives as input API endpoints, authentication credentials, geographic bounds, and time ranges.

The server sends HTTP requests through a communication interface to one or more external data services, and the server obtains as output a set of event records in a structured text format such as JSON.

The server parses each response, extracts fields including timestamp, latitude, longitude, event category, and severity indicator, and stores the extracted records in a temporary data buffer.

### Step 2:

The server structures the raw event information into tabular data.

The server receives as input the buffered event records from Step 1.

The server converts each record into a row of a tabular structure and aligns keys such as timestamp, location, and category into predefined columns.

The server outputs a tabular dataset in memory in which each row corresponds to one event and each column corresponds to a standardized attribute.

### Step 3:

The server performs missing-value correction and time normalization.

The server receives as input the tabular dataset from Step 2.

The server scans each column for null values or invalid entries, applies rules such as discarding events without location and imputing missing non-critical attributes using statistical estimates, and rewrites the affected cells.

The server converts all timestamps into a unified time zone, then computes and appends additional fields such as date, hour_of_day, and day_of_week.

The server outputs a cleaned and time-normalized tabular dataset ready for feature generation.

### Step 4:

The server generates numerical features from categorical and temporal attributes.

The server receives as input the cleaned tabular dataset from Step 3.

The server encodes categorical attributes such as event category and day_of_week into numerical vectors, for example by creating binary indicator columns, and the server rescales continuous attributes such as latitude, longitude, and hour_of_day using normalization or standardization functions.

The server concatenates all numerical attributes into a feature matrix, and outputs this feature matrix together with a mapping from rows to original event identifiers.

### Step 5:

The server executes clustering processing to identify high-risk regions.

The server receives as input the feature matrix from Step 4 and clustering parameters such as number of clusters or distance thresholds.

The server runs a machine learning algorithm that iteratively groups events according to similarity in the feature space, updates centroids or density estimates, and assigns a cluster label to each event.

The server outputs, for each event, a cluster label and also computes, for each cluster, aggregated statistics and a geographic centroid derived from the original coordinates.

### Step 6:

The server computes index values and designates high-risk regions.

The server receives as input the cluster-level statistics and geographic centroids from Step 5.

The server calculates, for each cluster, an index value based on at least event count, aggregated severity, and spatial density, using a predefined scoring function.

The server compares each index value with one or more thresholds and designates clusters exceeding the thresholds as high-risk regions.

The server outputs a list of high-risk regions, each described by an identifier, centroid coordinates, index value, and member event identifiers.

### Step 7:

The server aggregates event occurrence frequencies by time band.

The server receives as input the cleaned tabular dataset from Step 3 and the list of high-risk regions from Step 6.

The server assigns each event to a region using the region membership mapping, divides the time axis into discrete time bands, and counts how many events in each region fall into each time band.

The server compares the counts to a predetermined or dynamically computed threshold and marks time bands whose counts exceed the threshold as high-risk time bands for the corresponding regions.

The server outputs an association structure that links each high-risk region to one or more high-risk time bands.

### Step 8:

The server acquires map images for high-risk regions.

The server receives as input the centroid coordinates of the high-risk regions from Step 6.

The server constructs HTTP requests to a geographic information providing service, including each centroid, a zoom level, and a map type as parameters, and sends the requests through the network interface.

The server obtains as output map imagery descriptors or tile references corresponding to the requested areas and stores them with the region identifiers.

### Step 9:

The server constructs display data for map rendering.

The server receives as input the map imagery descriptors from Step 8, the high-risk regions from Step 6, and the index values and time-band associations from Step 7.

The server generates, for each region, a graphical specification that includes geometric shape, position, and visual attributes such as color and opacity derived from the index value.

The server bundles these specifications with map configuration parameters into display data objects and outputs these objects to be transmitted to the terminal.

### Step 10:

The terminal requests and receives display data from the server.

The terminal receives as input a user-initiated request for map-based risk information, including, for example, a current location or a region identifier.

The terminal sends a request to the server's application programming interface and receives as output the display data objects along with the associated map imagery configuration.

The terminal stores the received data in memory for subsequent rendering operations.

### Step 11:

The terminal renders the base map and high-risk regions.

The terminal receives as input the display data from Step 10 and map tiles or imagery obtained from the geographic information providing service.

The terminal composes the tiles into a base map view and draws graphical elements representing high-risk regions at their specified coordinates, applying the visual attributes specified in the display data.

The terminal outputs a rendered interactive map on the display, where regions with higher index values appear more prominent.

### Step 12:

The terminal handles a position designation operation by the user.

The terminal receives as input user actions such as clicks or taps on the displayed map.

The terminal determines which map element or geographic coordinate corresponds to the action, resolves the associated region identifier, and constructs a request message involving that identifier and coordinate.

The terminal outputs the request message and sends it to the server to obtain additional information for the designated region.

### Step 13:

The server acquires ground or aerial images for the designated region.

The server receives as input the request message from Step 12 including the region identifier and coordinate.

The server constructs a request to a visual information providing service with parameters such as latitude, longitude, and viewing direction, and transmits it via the communication interface.

The server obtains as output a ground image or aerial image or a resource locator for such imagery, associates it with the region identifier, and forwards this information to the terminal.

### Step 14:

The terminal presents the ground or aerial images in association with the map.

The terminal receives as input the imagery data or resource locator from Step 13.

The terminal loads the image resource, places it into a dedicated display area such as a panel or overlay, and synchronizes the map view to center or highlight the corresponding region.

The terminal outputs a composite display combining the interactive map and the street-level or aerial imagery so that the user can visually inspect the high-risk region.

### Step 15:

The server computes route candidates that avoid high-risk regions.

The server receives as input a departure point, a destination point, and the list of high-risk regions with their index values from Step 6.

The server loads a graph representation of the transportation network, assigns base weights to edges according to distance or travel time, and increases the weights of edges that intersect or lie within high-risk regions, with the increment proportional to the index values.

The server executes a route search technique such as a shortest path algorithm on the weighted graph to compute one or more route candidates, and outputs these route candidates with associated total cost values and lists of intersected regions.

### Step 16:

The user inputs a prompt sentence requesting analysis or advice.

The user receives as input the interactive map and optionally the presented routes and imagery from previous steps.

The user types a prompt sentence into an input field on the terminal, such as “Please describe the crime patterns around my current location on weekend nights and suggest a safer walking route home,” or “Compare the safety of Route A and Route B after 10 PM and recommend which one I should take.”

The user submits the prompt sentence, and the terminal outputs the prompt text along with context metadata.

### Step 17:

The terminal sends the prompt sentence and context metadata to the server.

The terminal receives as input the prompt sentence from Step 16 and context information such as current region identifier, selected time band, and identifiers of route candidates from Step 15.

The terminal packages this information into a request message containing the natural-language prompt and structured context fields and transmits the message to the server via the communication interface.

The terminal outputs the request and awaits a response containing generative analysis results.

### Step 18:

The server constructs query data for the generative AI model.

The server receives as input the request from Step 17 containing the prompt sentence and the structured context metadata.

The server retrieves detailed structured data relating to high-risk regions, high-risk time bands, and route candidates, formats this data into a structured description, and combines it with the prompt sentence to form query data.

The server outputs the query data in a format accepted by the generative AI model, such as a sequence of tokens or a messages array.

### Step 19:

The server obtains response information from the generative AI model.

The server receives as input the query data from Step 18.

The server submits the query data to the generative AI model, which internally encodes the tokens, applies multiple self-attention and feedforward layers, and generates an output sequence representing a natural-language response.

The server obtains as output the response information text from the generative AI model and logs it together with identifiers of referenced regions and routes, if detected.

### Step 20:

The server analyzes the response information and generates control information.

The server receives as input the response information from Step 19 and the structured data used to build the query.

The server parses the response text to detect mentions or labels corresponding to specific regions, time bands, or route candidates, and associates these mentions with internal identifiers by matching names or markers.

The server constructs control information specifying which regions or routes should be highlighted, de-emphasized, or annotated on the map, attaches the original response text, and outputs this combined result to be transmitted to the terminal.

### Step 21:

The terminal updates the map display and presents the generative explanation.

The terminal receives as input the control information and the response text from Step 20.

The terminal applies the control information to modify the map display state, for example by changing the color or thickness of certain routes, highlighting particular regions, or displaying labels indicating recommended paths or areas to avoid.

The terminal renders the response text in a display area such as a chat panel or information box, synchronized with the updated map visualization, and outputs a unified interface allowing the user to understand and act upon the generative AI model's explanation.

### Application Example 1

Description follows regarding a flow of the specific processing in an Application Example 1. The units of the system described below are implemented by the data processing device 12 and the smart device 14. The data processing device 12 is called a “server” and the smart device 14 is called a “terminal”.

Conventional route guidance systems and risk visualization systems typically rely on static or coarse-grained risk indicators and are not designed to integrate heterogeneous event information sources, such as structured statistical data and unstructured social stream data, into a unified, fine-grained spatio-temporal risk model. As a result, existing systems often fail to provide sufficiently accurate or timely assessments of risk for specific road segments or areas, particularly when risk patterns change rapidly over time or vary by time of day. Furthermore, these systems generally treat risk as a simple overlay or filter on top of a standard routing engine, without deeply coupling the risk model with the path-cost computation itself. This leads to suboptimal route selection where distance or travel time is minimized without an effective, data-driven consideration of dynamically evolving safety conditions.

In addition, many existing solutions present risk information and route rationale to users in a rigid, template-based manner. They are not able to generate context-sensitive, individualized explanations that address why a particular route is considered safe for a specific user profile, what localized risk factors exist along that route, and how those risk factors depend on time-of-day or other dynamic conditions. When users seek more detailed safety guidance, such as why certain streets are avoided or what community-level measures might be appropriate in a given area, conventional systems are unable to synthesize and articulate such guidance based on the underlying data in a flexible natural-language form.

Further, current systems lack a mechanism to leverage advanced generative models in a way that is tightly integrated with the internal risk computation pipeline. In particular, they do not construct detailed prompt sentences that encode the system's computed geospatial risk data, route candidates, and user-specified safety preferences as structured context for a generative model. Consequently, even if a generative model is used, it tends to produce generic advice that is not directly tied to the actual computed route, risk indices, or area-specific data held within the system.

From a computer technology standpoint, there is therefore a need for an improved data processing architecture and algorithmic pipeline that (i) standardizes and aggregates heterogeneous event information into spatial units with computed risk indices using statistical or machine learning processing, (ii) couples these risk indices with a road network graph such that route search explicitly optimizes over both cost and risk, and (iii) programmatically constructs and uses structured prompt sentences for a generative model to obtain individualized, data-grounded natural-language explanations and proposals. Such a system should improve the functioning of the computer by enabling more efficient and accurate spatio-temporal risk computation, safer and more relevant route selection, and richer user interaction without requiring manual expert intervention for each query.

The specific processing by the specific processing unit 290 of the data processing device 12 in Application Example 1 is realized by the following means.

The present invention provides a server comprising a processor configured to integrate heterogeneous event information sources into standardized spatio-temporal data including time information and location information, to convert address or area descriptors into position coordinates associated with predetermined spatial units or area units, to compute feature values for each spatial or area unit and to calculate a risk index for each unit by statistical or machine learning processing of the feature values, to generate geospatial risk data by associating the risk indices with road network information and area shape information acquired from a geospatial information service, to generate map display data that differentiates roads or areas according to the risk indices, to acquire and store visual information associated with high-risk areas in the geospatial risk data, to execute a route search process that weights costs of route elements based on the risk indices so as to compute route candidates that jointly consider distance or time and risk, to select a safe route from among the route candidates and generate route information including references to visual information for high-risk areas along the safe route, to generate a prompt sentence including the safe route and summary information of the geospatial risk data and to input the prompt sentence to a generative AI model, and to acquire, from the generative AI model, natural-language explanation information including reasons for selection of the safe route, explanations of high-risk areas, and time bands to be avoided, and to provide the explanation information in association with the route information in a format outputtable to a terminal device. This enables an improved computer-implemented risk-aware routing and explanation system that efficiently computes fine-grained spatio-temporal risk indices, integrates those indices into the core cost functions of route search, and leverages a generative model through structured prompt sentences to deliver individualized, data-grounded natural-language explanations and proposals, thereby enhancing both the technical operation of the routing engine and the quality of safety guidance presented to users.

The term “event information” refers to information representing occurrences of incidents or phenomena, including at least time information and location information, and optionally including type, severity, source, or other descriptive attributes of the incidents or phenomena.

The term “location information” refers to data that indicates a physical position on or near the surface of the earth, including, for example, coordinates, addresses, area identifiers, or other geographic descriptors.

The term “information source” refers to any system, service, database, sensor, or communication interface from which event information or related data can be obtained.

The term “standardized data” refers to data that has been converted from heterogeneous formats into a unified structure having consistent fields, units, and representations for at least time information and location information, thereby enabling integrated processing.

The term “time information” refers to data representing a temporal attribute of an event, including at least a date, a time of day, or a time interval.

The term “address information” refers to a textual or symbolic description of a location, including, for example, street names, numbers, administrative regions, or postal codes.

The term “area information” refers to data identifying a geographic area, including, for example, area identifiers, region codes, polygon definitions, or grid cell identifiers.

The term “position coordinates” refers to numeric values that specify a location in a coordinate system, including, for example, latitude and longitude or other geodetic coordinates.

The term “spatial unit” refers to a predefined subdivision of geographic space, such as a grid cell, segment, or tile, that is used as a basic unit for aggregating or analyzing event information.

The term “area unit” refers to a predefined geographic region, such as a neighborhood, district, administrative area, or other named region, that is used as a unit of analysis.

The term “feature values” refers to numeric or categorical values derived from event information for each spatial unit or area unit, including, for example, event occurrence frequency, event type distribution, time-of-day patterns, and reporting density.

The term “event occurrence frequency” refers to a value indicating how often events occur in a given spatial unit or area unit during a specified time period.

The term “event type” refers to a classification of an event, including, for example, categories such as theft, vandalism, accident, or other incident types.

The term “time-of-day band of occurrence” refers to a partition of a day into intervals, such as daytime, evening, or night, and to the association of event occurrences with those intervals.

The term “reporting density” refers to a measure indicating the number of event reports or related signals per spatial or temporal unit, or per population or other normalization factor.

The term “risk index” refers to a numeric or categorical indicator representing an estimated level of risk for a spatial unit or area unit, derived from feature values by statistical processing or machine learning processing.

The term “statistical processing” refers to operations using statistical methods, including, for example, averaging, regression, correlation analysis, clustering, or other statistical analyses applied to feature values.

The term “machine learning processing” refers to operations that apply a trained or trainable computational model to feature values to infer patterns or predictions, including, for example, classification, regression, or clustering methods.

The term “geospatial information service” refers to any service or system that provides geographic data, including, for example, road network data, area boundaries, map tiles, or coordinate-based information.

The term “road network information” refers to data describing transportation paths, including, for example, roads, intersections, paths, or links between locations, typically represented as a graph or network structure.

The term “area shape information” refers to geometric representations of areas, including, for example, polygons, multipolygons, or other shapes that define the boundaries of regions on a map.

The term “geospatial risk data” refers to data in which risk indices are associated with geographic elements, including at least road network information and area shape information, to represent spatial distributions of risk.

The term “map display data” refers to data formatted for rendering on a map display, including, for example, geometric elements, colors, symbols, and annotations that visually differentiate roads or areas according to attributes such as risk indices.

The term “visual information” refers to information in image or video form, or metadata thereof, that visually depicts a physical location or area.

The term “visual information providing service” refers to a service that supplies visual information associated with geographic locations, including, for example, street-level imagery services or other map-related imagery services.

The term “imaging device” refers to any device capable of capturing images or videos of physical scenes, including, for example, cameras, mobile imaging devices, or unmanned aerial imaging platforms.

The term “current position information” refers to location information that represents a position of a user or terminal device at or near real time, typically obtained via a positioning sensor or location service.

The term “destination information” refers to location information that represents a target location to which a route is to be calculated.

The term “terminal device” refers to an information processing apparatus operated by a user, including, for example, a mobile device, a smartphone, a tablet, or another client device capable of communication with the server.

The term “route search process” refers to computation that determines one or more paths between a start location and a destination location over a road network, typically by minimizing or optimizing a cost function.

The term “route element” refers to a component of a route, including, for example, a road segment, a node, a turn, or another unit of traversal within a road network.

The term “cost of route elements” refers to a value representing the cost associated with traversing a route element, including, for example, distance, travel time, or a combined cost that incorporates risk indices.

The term “route candidate” refers to a potential route between a start location and a destination location, computed by the route search process before a final route is selected.

The term “safe route” refers to a route selected from among route candidates whose safety level, as evaluated using risk indices and predetermined conditions, satisfies a specified safety criterion.

The term “route information” refers to data describing a route, including, for example, sequences of coordinates, route elements, navigation instructions, risk-related annotations, and references to associated visual information.

The term “reference information for visual information” refers to data that enables access to visual information for locations along a route, including, for example, identifiers, links, or metadata that associate route elements with visual information.

The term “summary information of the geospatial risk data” refers to condensed data describing key aspects of the geospatial risk data, including, for example, aggregated risk levels, noteworthy high-risk areas, and overall patterns relevant to a route.

The term “prompt sentence” refers to a structured natural-language or machine-interpretable text that encodes relevant context, including at least route information and summary information of geospatial risk data, and that is provided as input to a generative AI model.

The term “generative AI model” refers to a computational model configured to generate natural-language text or other content based on input data, including, for example, a large language model that produces explanations or proposals from a prompt sentence.

The term “explanation request sentence” refers to a prompt sentence specifically formulated to request an explanation or recommendation from a generative AI model regarding a safe route, associated risks, or related conditions.

The term “explanation information” refers to natural-language text or structured content output by a generative AI model in response to a prompt sentence, including at least reasons for route selection, descriptions of high-risk areas, and indications of time bands to be avoided.

The term “time bands to be avoided” refers to specific time intervals during which risk indices indicate elevated risk for certain areas or route elements and during which traversal is recommended to be avoided.

The term “outputtable format to a terminal device” refers to a data structure or representation that can be transmitted to and processed by a terminal device to present information to a user, including, for example, structured messages, user interface elements, or display-ready content.

The term “conditions or priorities related to safety” refers to user preferences or constraints regarding safety, including, for example, tolerance for high-risk areas, preference for lower risk over shorter distance, or time-of-day restrictions.

The term “individualized explanation” refers to explanation information that is adapted to specific conditions or priorities related to safety of a particular user, as reflected in the prompt sentence provided to the generative AI model.

The term “alternative route” refers to a route different from a currently selected route, proposed as another option that may better satisfy specified safety conditions, travel efficiency, or user preferences.

The term “causes of risk” refers to factors contributing to elevated risk in a given area, including, for example, concentrations of certain types of incidents, temporal patterns, or environmental conditions inferred from event information or other data.

The term “occurrence tendencies” refers to characteristic patterns in the occurrence of events, including, for example, trends over time, clustering by location, or dependence on time-of-day.

The term “countermeasure proposals” refers to recommended actions or strategies that are estimated to be effective in reducing risk in a given area, derived from geospatial risk data, explanation information, or additional rules.

The term “countermeasures to be implemented collectively in the area” refers to countermeasure proposals that are intended to be carried out at a community, organizational, or regional level, rather than solely by individual users, for improving safety in a target area.

In one embodiment, a server, a terminal, and a user cooperate to implement a risk-aware routing and explanation system. The server executes a software program on one or more processors and memories, the terminal executes a client application, and the user operates the terminal to obtain safe route guidance and explanations.

The server uses hardware that includes at least one general-purpose processor, a main memory, a non-volatile storage device, and a network interface. The server, for example, uses a computer system equipped with a multi-core central processing unit, a random access memory, a solid-state drive, and a network adapter connected to a packet-switched network.

The server executes an operating system such as a general-purpose server operating system and executes application code that is implemented, for example, in a high-level programming language such as Python. The server uses software libraries including a data analysis library (for example, Pandas), a machine learning library (for example, a library implementing decision trees, random forests, logistic regression, clustering, or gradient boosting), a geospatial processing library (for example, libraries implementing geographic dataframes and geometric operations), a map rendering library (for example, a web-based map visualization library), and a geocoding and routing library (for example, geopy). The server also uses an application programming interface client to access a generative AI model, which may be deployed on a separate computing system.

The terminal uses hardware that includes a processor, a memory, a wireless communication module, a positioning sensor such as a global positioning system receiver, a display device, and an input device such as a touch panel. The terminal executes a mobile operating system and a native or hybrid application that provides a graphical user interface to display maps, risk overlays, routes, explanation text, and visual information such as images or videos. The terminal uses a map software development kit to draw routes and overlays, and uses an operating system location service to obtain current position information.

The user operates the terminal to input a destination, to set conditions or priorities related to safety, and to request explanations or alternative routes. The user is not required to understand internal risk models or routing algorithms; the user only interacts via simple inputs such as selecting options, entering text, and tapping user interface elements.

The server acquires event information from a plurality of information sources. The server accesses a structured statistical database that stores historical incident records in formats such as comma-separated values or relational tables. The server also accesses one or more social stream services via their programmatic interfaces, using queries with location filters, time filters, and keywords related to incidents. The server receives heterogeneous records that contain different fields, such as textual descriptions, timestamps, approximate addresses, and, in some cases, position coordinates.

The server standardizes this event information into unified data structures. The server uses the data analysis library to represent event information as data tables with columns such as event identifier, event type, timestamp, address string, latitude, longitude, source identifier, and severity code. The server normalizes timestamp formats, converts them into a common time zone, and derives time-of-day bands by categorizing timestamps into intervals such as early morning, daytime, evening, and night. The server standardizes event type labels by mapping various textual labels into a finite set of normalized categories. The server thus transforms heterogeneous, noisy input data into standardized data that is suitable for further computation. This standardization improves data management by allowing uniform indexing, aggregation, and caching, which in turn reduces repeated parsing costs and improves processing speed.

The server converts address information or area information into position coordinates by using a geocoding function. The server applies a geocoding library that sends requests to a geospatial information service; the server transmits address strings and receives latitude-longitude pairs as geodetic coordinates. The server caches successful conversions in a key-value store, so that subsequent conversions of the same address avoid network requests and reduce communication load. The server then assigns each standardized record to a spatial unit or area unit. For example, the server defines a grid of rectangular cells over a target region and computes a grid index from the latitude-longitude coordinates. Alternatively, the server uses predefined administrative area polygons and determines which polygon contains each coordinate by geometric enclosure testing. The server stores an area identifier, such as a grid cell ID or an administrative region ID, in each record.

The server computes feature values for each spatial or area unit. The server performs aggregation operations that count the number of events per unit, per time-of-day band, and per event type. The server computes rates over different time windows, such as the average number of events per day in the last week versus the last month, which allows detection of increasing or decreasing tendencies. The server computes reporting density by dividing event counts by approximate population estimates, area sizes, or usage statistics, if present. The server also computes derived features, such as the ratio of severe events to all events in a unit and temporal concentration indices that indicate how strongly events concentrate in particular time bands.

The server uses a machine learning model to calculate a risk index for each spatial or area unit. In one embodiment, the server uses a supervised learning model such as a random forest classifier. The server prepares a training dataset by pairing feature vectors with labels representing known risk levels, such as low, medium, and high, based on historical expert assessment or thresholding of incident counts. The server initializes the random forest model with parameters such as the number of trees, maximum depth, and minimum samples per leaf. The server trains the model by iteratively building decision trees on bootstrap samples of the training data and computing splits that minimize impurity measures such as Gini impurity. The server stores the trained model parameters in non-volatile storage. In operation, the server loads the model into memory and applies it to feature vectors for all current spatial units to obtain probability outputs or risk scores. The server maps probability outputs to discrete risk levels by threshold rules that are designed to control false positive and false negative rates. The server thereby calculates risk indices in a manner that incorporates multi-dimensional feature relationships that are not easily captured by simple manual rules, improving prediction accuracy and robustness relative to linear thresholding.

In another embodiment, the server uses an unsupervised clustering model such as k-means or density-based clustering to group spatial units according to feature similarity and then assigns higher risk indices to clusters with high frequencies of specific event types or severe events.

The server selects the number of clusters based on evaluation measures such as silhouette scores and stores the cluster centers as model parameters. This alternative embodiment allows adaptation to regions where labeled risk levels are not available, while still exploiting multi-dimensional structure in the data.

The server acquires road network information and area shape information from a geospatial information service. The server downloads or queries a representation of the road graph in which nodes correspond to intersections or endpoints and edges correspond to road segments with attributes such as length, speed limit, and road classification. The server also acquires polygon geometries representing area units. The server associates each road segment with one or more spatial units or area units by computing intersections between segment geometries and area polygons or grid cells. The server stores, for each road segment, one or more risk indices derived from the associated spatial or area units. In this way, risk indices propagate from higher-level areas to individual graph edges.

The server executes a route search process on the road graph. In one embodiment, the server computes base costs for each road segment as a function of distance and estimated travel time, then adds a risk penalty term that is proportional to the risk index and possibly to the time-of-day band of the planned traversal. The server uses a shortest-path algorithm such as Dijkstra's algorithm or an A* algorithm with a heuristic based on geographic distance. The server therefore minimizes a composite cost that incorporates both travel efficiency and risk. This differs from conventional routing that only minimizes distance or time, and it modifies the internal cost structure of the routing engine itself. Because risk penalties are stored as pre-computed values associated with road segments, the server can reuse them across many routing queries, which increases computational efficiency. Additionally, because the server incorporates time-of-day dependent risk indices, the server can avoid segments that are only risky during specific time bands, improving both accuracy and usability.

The server generates map display data that visually differentiates roads and areas by risk level. The server encodes graphical attributes such as color gradients or hatch patterns corresponding to risk index values and associates those attributes with road geometries and area polygons. The server then generates map tiles or vector layers that can be rendered by the terminal with minimal additional processing. By pre-rendering or pre-encoding risk overlays, the server reduces the rendering load on the terminal and reduces latency in map updates.

The server acquires visual information for areas whose risk indices exceed a threshold. The server calls a visual information providing service that supplies street-level imagery based on coordinates, and receives uniform resource locators or image data. The server also accesses an internal media repository that stores images or videos collected by imaging devices such as cameras or unmanned aerial platforms. The server links each media item to area identifiers and risk indices, and stores these associations in a database to enable fast retrieval. This linkage enables the terminal to display images or videos for high-risk areas directly from route or risk annotations.

The server generates prompt sentences to be provided to a generative AI model. The server constructs structured text that encodes, in natural language, the selected safe route, key risk indices along the route, names or identifiers of high-risk areas, and time bands to be avoided, as well as user-specific safety preferences. The server restricts the prompt to essential context and uses predefined templates to ensure predictable structure. Example prompt sentences include:

“From my current location to the specified destination, describe the safest route based on the computed risk indices, explain which road segments are being avoided due to high risk, and indicate which time periods are particularly dangerous.”

“Given the crime statistics and social reports aggregated in the system for the last 30 days in this neighborhood, identify the safest streets to walk after 10 p.m. and explain which areas I should avoid and why.”

“Using the latest risk map and street-level images, describe potential safety concerns along the fastest route from my hotel to the nearest subway entrance, and propose an alternative route that reduces exposure to those risks.”

“Propose a safe jogging route of about five kilometers starting from my current location, avoiding areas with high risk indices identified in the system, and explain how the risk data influenced your route choice.”

The server transmits these prompt sentences, together with structured context data if supported, to a generative AI model. In one embodiment, the generative AI model is a transformer-based neural network that has been trained as a large language model. The model architecture includes multiple layers of self-attention mechanisms, feed-forward networks, and layer normalization, and is trained on a large corpus of text using an auto-regressive objective. The model parameters, such as attention heads, hidden dimensions, and layer counts, are selected to balance accuracy and inference speed.

The server adapts the generic generative AI model to the risk-aware routing domain by using domain-specific tuning or prompt engineering. The server uses domain-specific vocabulary, explicitly describes the meaning of risk indices, and includes explanations of how risk indices are computed. The server constrains the model's output length and style through decoding parameters such as temperature, top-k, and maximum token count. The server therefore obtains explanation information that is specific to the computed route and risk data, not generic safety advice.

The server associates explanation information with route information and visual information in a way that can be rendered on the terminal. The server stores route polylines, navigation instructions, risk annotations, references to images and videos, and explanation text in a structured format. The server then transmits this data to the terminal over a network using a communication protocol.

The terminal receives the route information, risk overlays, and explanation information, and renders them in the user interface. The terminal uses the map software development kit to draw the safe route as a polyline and to overlay risk-colored road segments and area regions.

The terminal displays explanation text in panels or pop-up windows that the user can open by tapping on a segment or area marker. When the terminal acquires updated current position information from its positioning sensor, the terminal updates the displayed position along the route and can display additional warnings when approaching segments with risk indices above a subthreshold value.

The terminal can also allow the user to adjust conditions or priorities related to safety after viewing initial explanations. For example, the user may choose a setting such as “prioritize safety even if travel time increases by more than 20%.” The terminal transmits the updated preferences to the server. The server then modifies the weighting of risk indices in the route cost function, increases the penalty for high-risk segments, and recomputes route candidates.

The server also modifies subsequent prompt sentences to include the new preferences, enabling the generative AI model to generate individualized explanations that reflect these preferences.

This architecture and processing provide technical improvements beyond mere automation of manual route selection. By pre-standardizing data, caching geocoding results, and pre-computing risk indices and risk-weighted edge costs, the server reduces the computational load for each routing query and improves response times. By integrating multi-dimensional feature-based risk indices into the internal cost structure of the routing engine, the server achieves higher accuracy in avoiding dangerous segments than simple distance-only calculations. By constructing structured prompt sentences that explicitly encode internal risk data and route structure, the server enables the generative AI model to produce explanations that are grounded in the actual internal state of the system, which improves the relevance and correctness of explanations.

In contrast to traditional human evaluation, where a person might manually read a list of statistics and write an explanation, the server applies non-intuitive and non-conventional rules. The server uses machine learning models that consider combinations of features that humans may not inspect systematically, and uses cost functions that combine risk, distance, and time in a finely tuned manner. The server also uses domain-specific templates for prompt sentences that are not natural for manual composition but are optimized for machine inference efficiency and explanation consistency. These technical measures reduce errors due to human oversight, enable real-time adaptation to changing conditions, and improve computational efficiency.

In one variation, the server uses a deep neural network instead of, or in addition to, a random forest. The server may employ a feed-forward network that takes feature vectors for spatial units as input, applies several fully connected layers with rectified linear unit activations, and outputs continuous risk scores. The server trains this network by minimizing a loss function such as mean squared error or cross-entropy using gradient-based optimization. The server may also perform data augmentation by perturbing coordinates within spatial units or by splitting time intervals to increase training samples, thereby improving generalization capabilities. The server periodically retrains or fine-tunes the model with new data to adapt to evolving patterns.

In another variation, the server may compress risk indices into lower-precision representations for storage and transmission, such as fixed-point values or bit-packed encodings, to reduce memory usage and communication bandwidth. The terminal can then decode these values for visualization, maintaining practical accuracy while reducing resource consumption.

Through these implementations and variations, the server, in cooperation with the terminal and the user, realizes a concrete technical system that improves computer-implemented risk assessment, routing efficiency, data management, and explanation generation. The system accomplishes this by specific data structures, algorithmic flows, and neural network-based models that are tightly integrated with geospatial processing and route computation, thereby achieving technical effects such as higher accuracy in risk-aware routing, reduced processing latency, improved computational efficiency, and richer, data-grounded interaction with the user.

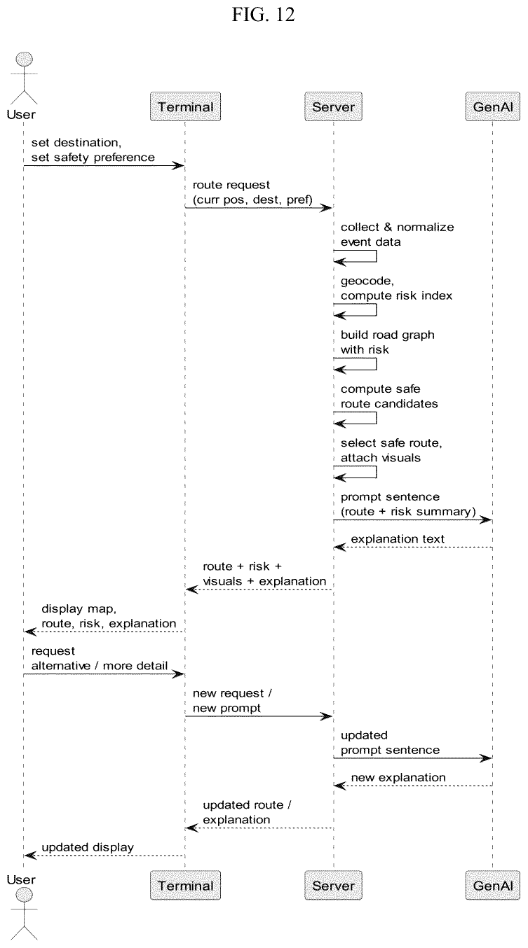

The following describes the processing flow using FIG. 12.

### Step 1:

The server acquires heterogeneous event information from multiple information sources.

The server receives, as input, structured event records from statistical databases and unstructured event records from social stream services, where each record may include a timestamp, an address string, a text description, and optional latitude and longitude. The server sends network requests to application programming interfaces of these information sources, receives responses in formats such as CSV or JSON, and writes the raw responses into temporary storage. The server thus outputs raw datasets containing mixed-format event information ready for standardization.

### Step 2:

The server standardizes the acquired event information into a unified data structure.

The server reads the raw datasets as input and uses a data analysis library to load them into tabular data structures with columns such as event identifier, normalized event type, unified timestamp, address, latitude, longitude, source identifier, and severity level. The server converts timestamps into a common time zone and derives a time-of-day band for each event by mapping the timestamp into predefined intervals. The server normalizes event type labels by mapping various source-specific labels into a controlled vocabulary. The server outputs standardized records in which all events share a consistent schema that can be indexed and queried efficiently.

### Step 3:

The server converts textual location descriptors into position coordinates and assigns spatial units.

The server uses standardized records containing address information or incomplete location information as input. The server calls a geocoding function that sends address strings to a geospatial information service and receives position coordinates as output. The server caches address-to-coordinate mappings in a key-value store to avoid repeated network calls for identical addresses. The server then computes, from each coordinate, a spatial unit identifier such as a grid cell index or an area identifier by applying grid partitioning or polygon containment tests. The server writes the computed coordinates and spatial unit identifiers back into the standardized records, producing enriched records that include precise geolocation and spatial unit annotations.

### Step 4:

The server aggregates event information per spatial unit and computes feature values.

The server uses the enriched records as input and groups them by spatial unit identifier. For each spatial unit, the server counts the number of events per event type, per time-of-day band, and per predefined time window such as daily, weekly, and monthly intervals. The server may also compute ratios of severe events to total events, temporal concentration indices, and reporting density by dividing counts by area size or population estimates if available. The server outputs a feature table in which each row corresponds to a spatial unit and each column corresponds to a computed feature value.

### Step 5:

The server calculates a risk index for each spatial unit using machine learning processing.

The server takes as input the feature table for spatial units and, in one embodiment, a trained machine learning model such as a random forest classifier. The server loads the model parameters from storage and applies the model to each feature vector, performing internal operations such as decision tree traversal and aggregation of tree outputs. The server thereby computes, for each spatial unit, a probability distribution or score over risk levels. The server then maps the scores to discrete risk indices such as low, medium, or high by applying threshold rules designed to balance false positives and false negatives. The server outputs a risk table including spatial unit identifiers and corresponding risk indices.

### Step 6:

The server associates risk indices with road network elements and generates geospatial risk data.

The server uses road network information and area shape information as input, along with the risk table. The server computes, for each road segment, one or more overlapping spatial units or area units by testing geometric intersection or containment between segment geometries and area shapes. The server then calculates a risk index for each road segment by combining the risk indices of intersecting spatial units, for example by taking a maximum or weighted average. The server writes risk indices as attributes of the road segments and compiles a set of area polygons with associated risk indices, thereby producing geospatial risk data that binds risk values to concrete geographic entities.

### Step 7:

The server generates map display data that visually encodes risk information.

The server takes geospatial risk data as input and determines graphical properties for each road segment and area polygon, such as colors, line thicknesses, and transparency, based on the associated risk indices. The server uses a map rendering library to produce vector layers or map tiles in which higher-risk elements are rendered, for example, in warmer or more saturated colors. The server optionally simplifies geometries and pre-renders frequently requested regions to optimize rendering speed. The server outputs map display data that the terminal can use directly to draw risk-aware maps with low computation overhead.

### Step 8:

The server acquires and organizes visual information for high-risk areas.

The server selects, as input, spatial units, area polygons, and road segments whose risk indices exceed a predefined threshold. For each such geographic element, the server calls a visual information providing service, providing coordinates and optional orientation parameters, and receives image metadata or image files as output. The server also queries internal media storage for images or videos captured by imaging devices that are tagged by coordinates or area identifiers. The server associates each visual item with its geographic element and risk index, and stores this association in a database. The server outputs a visual information index that links high-risk areas and segments to one or more visual resources.

### Step 9:

The terminal acquires current position information and user-specified destination information.

The terminal uses a positioning sensor and a location service to obtain the current position as input, represented by coordinates and accuracy metrics. Separately, the user operates the terminal to input a destination, such as by entering an address or selecting a point on a map, and to set optional safety preferences, such as prioritizing safer routes over shorter routes.

The terminal combines the current position, destination, and safety preferences into a routing request data structure. The terminal outputs this routing request and transmits it to the server over a communication network.

### Step 10:

The server computes route candidates using risk-weighted costs.

The server receives the routing request as input, along with the previously generated road network information and geospatial risk data. The server constructs a graph in which nodes represent intersections or endpoints and edges represent road segments with attributes including distance, estimated travel time, and risk index. The server computes a composite cost for each edge by combining distance or travel time and a risk penalty determined by the risk index and the user's safety preferences. The server then executes a route search algorithm such as Dijkstra or A* on this graph, using the current position as the start node and the destination as the goal node. The server obtains one or more route candidates as sequences of edges and nodes, and outputs these route candidates with their total composite costs and safety metrics.

### Step 11:

The server selects a safe route and generates route information.

The server uses the set of route candidates and their associated metrics as input. The server evaluates each candidate based on criteria such as total composite cost, travel time, cumulative risk index, and percentage of segments in each risk level. The server selects at least one route whose safety characteristics satisfy predefined conditions or the user's specified preferences as the safe route. The server then constructs route information that includes the ordered list of coordinates, turn-by-turn instructions, per-segment risk annotations, and references to visual information for any high-risk areas along the route. The server outputs the safe route and associated route information in a structured form.

### Step 12:

The server constructs a prompt sentence for a generative AI model using internal route and risk data.

The server takes as input the safe route, the summary information of the geospatial risk data relevant to this route, and the user's safety preferences. The server extracts key elements such as descriptions of high-risk segments, time-of-day dependent risks, and alternative paths that were rejected. The server then fills a textual template to generate a prompt sentence that concisely encodes this context in natural language. For example, the server may generate a sentence of the form:

“Given the following route, which avoids segments with high risk indices and emphasizes safety over minimal travel time, explain why this route is selected, identify any remaining medium-risk segments, and specify which time periods should be avoided on this route.” The server outputs this prompt sentence as text to be sent to the generative AI model.

### Step 13:

The server obtains explanation information from the generative AI model and associates it with the route.

The server sends the prompt sentence as input to the generative AI model through an interface and receives, as output, natural-language text that includes explanations of route choice, descriptions of high-risk or medium-risk segments, and recommended time bands to avoid. The server may enforce constraints on the generative process by specifying parameters such as maximum length and style. The server then attaches the received explanation information to the route information data structure, linking specific paragraphs or sentences to particular segments or areas when possible. The server outputs enriched route information that now includes both structural route data and contextual explanation text.

### Step 14:

The server transmits enriched route and visualization data to the terminal.

The server takes as input the enriched route information, risk-encoded map display data, and visual information references associated with the selected safe route. The server packages these into a response message in a format agreed upon with the terminal, including route geometry, navigation instructions, per-segment risk attributes, links or identifiers for images and videos, and explanation text obtained from the generative AI model. The server compresses or optimizes the payload as needed to reduce transmission size and then sends the response over the network. The server outputs a network message that the terminal receives and processes.

### Step 15:

The terminal renders the safe route, risk overlays, and explanations for the user.

The terminal receives the response message from the server as input and parses the contained data. The terminal passes route geometry and risk attributes to the map software development kit to draw the safe route as a path on the map and overlay colored or styled segments corresponding to different risk levels. The terminal displays explanation text in panes or tooltips that are linked to route segments or area markers. The terminal fetches images or videos using the references included in the response and shows thumbnails or full-screen views when the user selects them. The terminal outputs a visual and textual presentation on the display that allows the user to understand the safe route and the underlying risk context.

### Step 16:

The user reviews the presented information and optionally requests an alternative route or additional explanation.

The user observes, as input, the displayed safe route, risk overlays, explanation text, and visual information on the terminal. The user may decide that an even safer route is desired or may seek more detail about certain segments. The user interacts with the terminal by issuing a new request, for example by pressing a button labeled “More safety” or by entering a natural-language question such as “Explain in more detail why this street is considered medium risk and suggest a route that completely avoids it.” The terminal sends this new request, possibly as an updated routing request or as a new prompt sentence, to the server.

The user thus outputs refined preferences or questions that trigger another cycle of computation and explanation in the system.

It is also possible to incorporate an emotion engine for estimating the user's emotions. That is, the specific processing unit 290 may estimate the user's emotions using an emotion identification model 59, and perform specific processing based on the estimated emotions.

### Example 2

Description follows regarding a flow of the specific processing in an Example 2. The units of the system described below are implemented by the data processing device 12 and the smart device 14. The data processing device 12 is called a “server” and the smart device 14 is called a “terminal”.

Conventional route guidance systems typically optimize for travel time or distance using static map data and, at most, simple rule-based constraints. Such systems do not effectively integrate heterogeneous spatiotemporal data such as crime occurrence records, user-perceived safety feedback, and dynamically changing environmental factors, nor do they leverage advanced machine learning models in a structured way to evaluate and improve route safety. As a result, existing systems often fail to provide routes that reflect nuanced, real-world safety conditions, especially at specific times of day or in particular micro-locations, and cannot continuously adapt their internal risk models based on accumulated usage data.

Furthermore, traditional architectures treat artificial intelligence components, including generative models, as isolated “black box” add-ons that merely generate text outputs, without a systematic mechanism to convert complex environmental and feedback data into machine-interpretable risk rules and to feed those rules back into the core routing engine. This leads to suboptimal use of computation resources, fragmented data flows, and difficulty in maintaining or auditing how safety-related decisions are derived.

In addition, user feedback on perceived safety, typically provided as free-form natural language, is either ignored or processed manually, and is not effectively incorporated into the machine-readable data structures that control risk scoring for road segments. As a consequence, route safety estimation remains rigid, slow to adapt, and unable to reflect localized, time-sensitive concerns that are not yet visible in official statistical records. There is therefore a need for an improved computer-implemented system that (i) systematically acquires, normalizes, and stores spatiotemporal risk-related data; (ii) computes and maintains dynamic risk indices for route elements; (iii) integrates a generative AI model via structured prompt sentences to derive, update, and apply risk rules; and (iv) uses such rules within a route computation engine to generate safer routes and explanatory guidance in real time. This improvement should manifest as an enhancement of the functioning of the computer system itself, including improved data processing pipelines, more effective use of storage and computation in risk evaluation, and an automated feedback loop that continuously refines risk indices using both official records and user-provided information.

The specific processing by the specific processing unit 290 of the data processing device 12 in Example 2 is realized by the following means.

The present invention provides a server comprising a processor configured to acquire, from a user terminal, position information and destination information of a user together with a natural language request relating to a safe route, and to normalize and store, in a storage device, spatiotemporal information including crime occurrence records obtained from an external information source as record information; to analyze the record information using statistical processing and machine learning processing in order to extract crime occurrence tendencies and identify locations and time periods in which crimes are likely to occur; to acquire geospatial information and map the identified locations onto the geospatial information as area information, and to calculate, for each path element, a risk index based on the area information and the crime occurrence tendencies; to perform route search processing that calculates a plurality of candidate routes between the position information and the destination information by applying weighting to route components according to the risk index; to generate a structured prompt sentence including information relating to the plurality of candidate routes and the risk index, to input the structured prompt sentence to a generative AI model, and to obtain, from the generative AI model, evaluation information for the plurality of candidate routes and identification information of a recommended route; to generate route information for a selected safe route and explanation information including reasons why the selected safe route is determined to be safe, based on the identification information and the evaluation information, and to output the route information in a format suitable for display on the geospatial information; to acquire, after movement along the selected safe route, evaluation information relating to perceived safety and free-form description information from the user, and to store the evaluation information and the free-form description information in association with the record information and the risk index; and to perform natural language processing on the stored evaluation information and the free-form description information, generate a further structured prompt sentence including an analysis result, input the further structured prompt sentence to the generative AI model to obtain update rules for the risk index, and update the risk index for each path element based on the update rules. This enables the computer system to iteratively refine and apply dynamic, data-driven risk indices for route elements using both official spatiotemporal records and user feedback, to integrate a generative AI model into the routing pipeline through structured prompt sentences, and thereby to improve the functioning of the route computation and guidance processes themselves, resulting in safer and more context-aware route recommendations and explanations.

The term “processor” refers to a hardware processing unit or combination of hardware processing units, such as a central processing unit or a graphics processing unit, that executes instructions to perform the functions described herein.

The term “storage device” refers to a non-transitory computer-readable medium, such as a magnetic disk, optical disk, semiconductor memory, or solid-state storage, that stores data and programs used by the processor.

The term “terminal device” refers to an electronic apparatus operated by a user, such as a mobile communication device, portable computing device, or fixed computing device, that is capable of sending information to and receiving information from the server.

The term “position information” refers to data representing a geographic location of a user or device, including, for example, coordinate information such as latitude and longitude, or equivalent location descriptors derived from positioning technology.

The term “destination information” refers to data representing a target location to which a user intends to travel, including coordinate information, address information, facility identifiers, or other data that can be resolved into a geographic position.

The term “natural language request” refers to text or voice information expressed in a human language, provided by a user, that indicates a desire for a route or guidance, and that can be processed by the system as part of a prompt sentence.

The term “spatiotemporal information” refers to data that includes both spatial attributes indicating locations and temporal attributes indicating times or time periods, such as crime occurrence records with associated locations and timestamps.

The term “crime occurrence record” refers to a data item describing an incident of unlawful or harmful activity, including at least information about the type of incident, a location at which the incident occurred, and a time at which the incident occurred.

The term “record information” refers to normalized and structured data stored in the storage device, obtained from raw spatiotemporal information, and used by the processor for analysis of patterns and tendencies.

The term “statistical processing” refers to computation that applies statistical techniques, such as aggregation, clustering, or frequency analysis, to data in order to derive distributions, trends, or numerical indicators.

The term “machine learning processing” refers to computation that uses a model trained on data, such as a classification model, regression model, or clustering model, to infer patterns, tendencies, or predictions from input data.

The term “crime occurrence tendency” refers to a pattern or likelihood of crime incidents occurring in association with particular locations, time periods, or contextual conditions, as inferred from record information.

The term “geospatial information” refers to digital data representing features of geographic space, such as roads, areas, landmarks, or boundaries, together with their locations and shapes.

The term “area information” refers to data representing one or more geographic regions, such as polygons or buffered areas, that are associated with particular attributes, including regions in which crimes are likely to occur.

The term “path element” refers to a unitary component of a route, such as a road segment, link, or edge in a transportation network, having associated attributes including geometric shape and connectivity.

The term “risk index” refers to a numerical or categorical value associated with a path element or geographic region, indicating a degree of risk, hazard, or safety level computed from record information and other inputs.

The term “route component” refers to a part of a route consisting of one or more path elements that contribute to the overall path from origin to destination.

The term “route search processing” refers to computation that determines one or more routes between an origin and a destination by exploring a network of path elements according to a cost function or constraints.

The term “candidate route” refers to a possible path between an origin and a destination, represented as a sequence of path elements or geographic points, that is considered by the processor during route selection.

The term “prompt sentence” refers to a structured text or textual representation, including natural language and optionally structured data, that is provided as input to a generative AI model to request a particular type of output.

The term “generative AI model” refers to a machine learning model configured to generate output data, such as text or structured information, in response to input data including prompt sentences, and that has been trained on example data.

The term “evaluation information” refers to data describing the merit, quality, or suitability of one or more candidate routes, such as safety scores, preference indications, or explanatory comments, as generated by the processor or the generative AI model.

The term “identification information” refers to data that uniquely or specifically identifies a particular route, element, or item, such as a route identifier, index, or label used by the system.

The term “selected safe route” refers to a route chosen by the processor from among candidate routes based at least on the risk index and evaluation information, and regarded as preferable from a safety perspective.

The term “route information” refers to data defining a selected route, including, for example, a sequence of path elements, coordinate points, and associated attributes used for rendering and navigation.

The term “explanation information” refers to natural language or structured text describing one or more reasons or factors for which a route is selected, including references to risk indices, areas avoided, or characteristics of chosen path elements.

The term “geospatial display format” refers to a representation of route information or area information that can be rendered on a map or similar geographic user interface on a terminal device.

The term “evaluation information relating to perceived safety” refers to data provided by a user, such as ratings or labels, that express a subjective assessment of safety experienced along a route.

The term “free-form description information” refers to unconstrained natural language text entered or spoken by a user, describing impressions, incidents, or observations related to a route or location.

The term “natural language processing” refers to computational methods that analyze, interpret, or transform text or voice data expressed in human language, including tasks such as tokenization, sentiment analysis, and key phrase extraction.

The term “update rule” refers to a condition or formula used to modify the risk index of a path element or region, derived by analysis or by the generative AI model, and applied to recompute risk indices.

The term “guidance information” refers to natural language content or structured instructions generated for presentation to a user, explaining a selected route or providing navigation or safety-related advice.

The term “visual guidance” refers to information presented on a display, such as a map rendering, icons, text labels, or highlights, that indicate a route, directions, or safety-related information.

The term “voice guidance” refers to audio output, such as synthesized speech, that presents navigation instructions or explanation information to a user.

The term “regional safety measure” refers to a proposed action, policy, or intervention to improve safety within a geographic area, such as installation of lighting, patrol allocation, or infrastructure modification.

The term “structured information” refers to data organized in a defined format, such as a table, list, or marked-up text, that can be systematically interpreted and processed by the processor.

The term “guideline information” refers to information describing recommendations, priorities, or strategies for planning and implementing measures in a region, derived from analysis by the processor and the generative AI model.

In one embodiment, a server, a terminal, and a user cooperate to implement a safe-route guidance system that utilizes spatiotemporal incident data and a generative AI model.

The server executes software modules on one or more computing nodes, each node comprising at least one processor such as a central processing unit and, optionally, a graphics processing unit, and at least one storage device such as a semiconductor memory or a magnetic disk. The server executes an operating system such as a general-purpose server operating system and a web application framework such as a typical HTTP framework in a programming language such as Python or JavaScript. The server communicates with the terminal through a communication network such as a mobile network and a packet-switched network using secure communication protocols.

The terminal is, for example, a smartphone, tablet, or other portable computing device including a processor, a memory, a display, an input interface, and a position sensor such as a global navigation satellite system module. The terminal executes an application that interacts with the server through a network and presents maps, routes, and explanation information to the user. The user operates the terminal to request a safe route and to provide feedback after movement.

The server implements multiple software modules including a data acquisition module, a normalization and storage module, a risk computation module, a routing module, an AI interaction module, a feedback analysis module, and a secure communication module. The server uses a relational database management system such as a relational database with a spatial extension to store geospatial data structures. The server uses software libraries such as a numerical computation library, a data frame library, a geospatial library, and a network analysis framework for processing high-volume spatiotemporal data and computing risk indices for path elements.

The server stores crime occurrence records, user feedback records, and derived risk parameters in structured tables. The server represents a road network as a directed graph, in which each node corresponds to an intersection or a geospatial point, and each edge corresponds to a path element such as a road segment. The server associates each edge with attributes including geometric shape encoded as a polyline, base travel time, and a dynamic risk index. The server stores these structures in tables accessible through spatial queries.

The server acquires external spatiotemporal information from public or private data sources.

The server uses an HTTP client library to access application programming interfaces or to download structured files such as text-based tabular files. The server parses each record and converts it into a normalized format with fields including an incident type, a timestamp, and geographic coordinates. When only address strings are provided, the server sends requests to a geocoding service and receives coordinates. The server then stores normalized records in an internal table called, for example, a “crime_events” table.

The server executes statistical processing using a numerical library and a data frame library.

The server aggregates crime events in both space and time by performing group-by operations over spatial grid cells and time intervals. The server uses clustering algorithms such as a density-based clustering algorithm implemented in a machine learning library to identify clusters of crime events. The server converts clusters into polygons using a geospatial library that computes convex hulls or buffers around incident points. The server thereby obtains area information representing locations where crimes are likely to occur.

The server computes preliminary risk values for each path element by combining crime density in proximity to the path element, time-of-day crime distribution, and incident type severity. The server stores these risk values in a “road_risk” table keyed by path element identifiers. The server uses spatial functions in the spatial database extension to determine whether the geometry of a path element intersects a high-risk area. The server also uses time-based weighting factors to adjust the risk index according to the expected travel time.

The server integrates a generative AI model using an AI interaction module. The generative AI model is, for example, a transformer-based neural network model that has an encoder-decoder architecture with multiple self-attention layers, feed-forward layers, and layer normalization. The model parameters include a set of weight matrices that transform token embeddings through attention heads and dense layers. The server stores the model either locally or accesses it through a remote AI service.

The server pre-processes structured data into textual representations that include field names and values. The server generates a prompt sentence that combines natural language instructions and serialized summaries of statistics and risk distributions. For example, the server generates a prompt sentence such as:

“You are analyzing urban safety data. Here are recent crime hotspots and time distributions in a city. Identify typical features of locations where crimes are likely to occur and typical high-risk time periods. Output a brief explanation and a list of rules describing spatial and temporal risk patterns.”

The server tokenizes the prompt sentence using a tokenizer compatible with the generative AI model, converts tokens to embeddings, and forwards them through the neural network. Internally, the model computes self-attention scores for each token by multiplying query, key, and value matrices, normalizing with a softmax operation, and aggregating context vectors. The model then passes the intermediate vectors through feed-forward layers with activation functions such as rectified linear units or similar nonlinearities. The server receives output tokens, decodes them into text, and parses rule-like segments into structured rule objects.

The server converts descriptions such as “streets with low lighting near stations between 20:00 and 23:00 show increased incidents” into machine-usable rules by requesting the model to output them in a constrained textual format. The server then converts these textual rules into data structures that specify feature conditions on path elements: for example, proximity to public transport hubs, absence of certain infrastructure attributes, or high incident density thresholds at particular times. The server applies these rules to the road network using conditional statements and database queries to update risk indices.

The server uses a routing module to compute candidate routes. The server either calls an external routing engine through an application programming interface or runs an internal graph-based shortest-path algorithm using a network analysis framework. The server constructs a cost function that includes both base travel time and risk index weights. The cost function is non-linear in some embodiments, where high risk indices produce super-linear increases in cost, thereby strongly penalizing routes through high-risk paths.

The server leverages the generative AI model not simply to select routes based on high-level textual reasoning, but to transform complex multi-dimensional route attributes into ranking rationales. The server generates a candidate selection prompt sentence such as: “You are selecting the safest walking route for a child. Here are three candidate routes with travel times, risk scores, and types of streets. Choose the best route that balances safety and reasonable travel time. Return the identifier of the chosen route and a short explanation.”

The server converts route attributes into textual tables embedded in the prompt sentence. The generative AI model processes the prompt and outputs a route identifier and explanatory text.

The server validates that the chosen route satisfies predetermined safety thresholds. This interaction offloads complex multi-factor trade-off reasoning from fixed rules to a flexible, learned model, while the server maintains strict constraints on allowable outputs.

The server generates explanation information for presentation to the user. The server prepares a prompt sentence containing details about the selected safe route and the high-risk areas that were avoided. For example, the server generates a prompt sentence such as:

“Create a short explanation of why the following walking route is considered safe. The route avoids these high-risk streets and uses these safer streets. Write 2-3 sentences in simple language.”

The generative AI model outputs an explanation such as: “This route avoids streets where several recent incidents have occurred at night and instead uses main roads that are well-lit and frequently used by many pedestrians.” The server stores this text as explanation information linked to the route.

The server also processes user feedback. The user operates the terminal after completing the route and inputs a rating and free-form comments. The terminal sends the feedback to the server. The server stores feedback in a “route_feedback” table associated with the corresponding path elements and time intervals. The server uses a natural language processing library to extract sentiment scores, mentions of specific locations, and references to conditions such as lighting or crowd density.

The server again uses the generative AI model to synthesize adjustment rules for risk indices.

The server generates an analysis prompt sentence such as:

“Here are road segments with their current risk scores, recent incident statistics, and user feedback comments with sentiments. Suggest how to adjust the risk scores of these segments and summarize the reasons.”

The generative AI model returns a set of textual recommendations. The server parses these recommendations, converts them into explicit update rules such as “increase risk by a certain amount where repeated negative feedback about poor lighting exists,” and applies them to recompute risk indices in the road_risk table. The server uses these updated indices for subsequent routing requests, enabling a continual improvement loop.

The server improves computer technology by structuring data pipelines, memory usage, and computation patterns to reduce redundant processing. The server stores aggregated summaries of crime events and feedback in pre-computed tables, which reduces computational load for each route computation. The server applies incremental updates to risk indices by processing only affected path elements rather than recomputing entire city-wide matrices. This reduces the number of database operations and improves responsiveness for real-time route requests.

The server further improves technical performance by bundling necessary attributes for route evaluation into compact data structures that are transmitted to the generative AI model. The server compresses attributes into concise textual descriptions and uses selective sampling of route segments, which reduces payload size and lowers communication latency. The server may implement caching of generative AI model outputs for similar route contexts, thereby reducing the number of AI calls and saving computation.

The server's use of a generative AI model differs from human manual analysis in that the model operates on high-dimensional embeddings rather than explicit symbolic rules, thereby capturing nonlinear relationships between spatial patterns, temporal patterns, and route attributes. The server configures the model with a training procedure that uses a large corpus of text data, including documents describing urban safety, navigation, and human mobility behavior. The model is trained using a sequence-to-sequence objective, minimizing a loss function such as cross-entropy between predicted and actual tokens. During fine-tuning for the specific application, the server may provide examples of route evaluation tasks and route explanation tasks, and adjust model parameters using gradient-based optimization with learning rate schedules and regularization techniques.

The server's pipeline provides technical advantages such as improved accuracy of risk estimation and reduced false negatives in identifying unsafe areas. By combining statistical clustering, machine-learned patterns, and user feedback interpreted via natural language processing, the server maintains a refined, context-aware risk index that adapts over time.

The server also improves the efficiency of route computation by integrating risk costs into graph search algorithms, thereby avoiding post-hoc filtering of unsafe routes and reducing the number of search iterations.

The terminal uses its position sensor to provide the server with continuous updates about the user's current location. The terminal receives updated route information from the server when deviations occur, and the terminal renders new polylines on the display with minimal delay.

The terminal may prefetch map tiles and route segments based on predictions of the user's movement direction, reducing network latency and improving the continuity of guidance.

In another embodiment, the server runs the generative AI model locally on a hardware accelerator to avoid dependence on external AI services. The server then uses on-device memory to store model parameters and implements quantization or mixed-precision arithmetic to reduce memory usage and accelerate inference. The server thereby achieves lower inference latency and greater control over data privacy.

In yet another embodiment, the server supports different modes of risk evaluation. In a basic mode, the server relies primarily on statistical aggregation and simple rules without using the generative AI model. In an enhanced mode, the server enables AI-based pattern extraction and explanation generation. The server may switch between modes based on system load or user preference, thereby balancing computational cost and explanation richness.

In an alternative embodiment, the server extends the same architecture to other types of risk beyond crime, such as natural hazard risk or traffic accident risk. In such embodiments, the server acquires different types of incident records, adjusts feature definitions and risk weighting functions, and uses the same generative AI interaction to derive patterns and explanations. The underlying data structures and routing algorithms remain applicable.

The system, as described, is not limited to simple automation of human decision-making but rather implements a concrete improvement in how computing devices process and integrate heterogeneous data, how they compute and update risk indices for geospatial networks, and how they generate human-understandable explanations from internal data structures. The server thus enhances the internal functioning of computer systems by structuring data flows, optimizing route search algorithms with dynamic risk factors, and using a generative AI model as a component of a technically constrained and auditable processing pipeline.

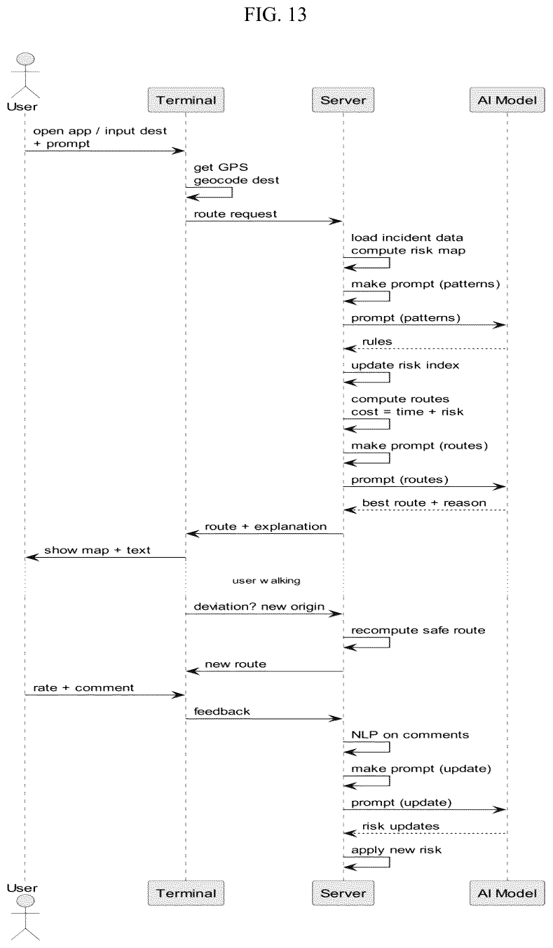

The following describes the processing flow using FIG. 13.

### Step 1:

The user operates the terminal to request a safe route. The user launches an application on the terminal, allows location access, and enters or selects a destination. The user optionally inputs a natural language request as a prompt sentence, for example, “Please show me a safe walking route from my home to the school, avoiding areas where crimes often occur at night.”

Input: Current position (from the terminal's location sensor), destination text or preset identifier, and the prompt sentence typed by the user.

Output: A structured request object inside the terminal containing origin coordinates, destination text, and the prompt sentence.

### Step 2:

The terminal converts the destination into coordinates and sends the request to the server. The terminal calls a geocoding service to resolve the destination text into latitude and longitude, constructs a JSON message including origin coordinates, destination coordinates, terminal ID, and the prompt sentence, and sends this JSON message to the server over a secure channel.

Input: Origin coordinates, destination text, and the prompt sentence from Step 1.

Output: A network message transmitted to the server containing origin coordinates, destination coordinates, and the prompt sentence.

### Step 3:

The server receives and validates the route request. The server parses the JSON message, checks that coordinates are numeric and in valid ranges, checks that the prompt sentence is a valid text string, and assigns a unique request ID. The server stores the request data in a database for later reference.

Input: JSON message containing origin coordinates, destination coordinates, terminal ID, and the prompt sentence.

Output: A validated request record stored in the database, including a request ID referencing the origin, destination, and prompt sentence.

### Step 4:

The server retrieves and normalizes spatiotemporal incident data. The server accesses external data sources, retrieves incident records that may include crime occurrence records, converts addresses to coordinates if needed, and normalizes fields such as incident type and time format. The server removes duplicate records and stores cleaned entries in an internal table.

Input: Raw incident data obtained from external sources, such as tabular files or API responses.

Output: A set of normalized incident records stored in a database table with standardized fields for location, time, and type.

### Step 5:

The server computes base risk indicators for geographic areas. The server groups incident records by spatial regions and time intervals, calculates incident frequencies, and applies clustering algorithms to identify dense clusters. The server creates polygons representing high-risk areas and assigns preliminary risk scores to each area based on incident counts, severity, and recency.

Input: Normalized incident records from Step 4.

Output: Area objects with associated preliminary risk scores and polygons stored in a spatial database.

### Step 6:

The server propagates area risk to path elements in the road network. The server loads road network data, determines which path elements intersect or approach high-risk polygons using spatial queries, and computes a base risk index for each path element by combining area risk scores and attributes of the path element (such as type of road or proximity to facilities).

Input: High-risk area polygons and base risk scores from Step 5, and road network data from a map database.

Output: A table of path elements with initial risk indices stored under a road risk data structure.

### Step 7:

The server prepares statistical summaries and constructs a first prompt sentence for the generative AI model. The server aggregates statistics such as incident type distributions, time-of-day patterns, and spatial density, converts these into textual or structured summaries, and embeds them into a prompt sentence instructing the generative AI model to identify features of high-risk locations and time periods.

Input: Aggregated incident statistics and high-risk area metadata from Steps 5 and 6.

Output: A first prompt sentence that describes the data context and requests pattern extraction, ready for input to the generative AI model.

### Step 8:

The server invokes the generative AI model to derive pattern-based risk rules. The server transmits the first prompt sentence to the generative AI model, receives a text response describing risk-related patterns (for example, “streets with poor lighting near transportation hubs at night have elevated risk”), and extracts rule-like segments. The server optionally requests a follow-up response where the generative AI model rewrites the patterns into explicit condition descriptions.

Input: The first prompt sentence generated in Step 7.

Output: A set of textual risk rules and explanations returned by the generative AI model.

### Step 9:

The server converts textual risk rules into structured rule objects and updates risk indices.

The server parses the textual rules to identify conditions such as “distance to a station,” “lighting level,” or “time window,” maps these conditions to attributes in the road network and incident data, and encodes them as rule objects. The server applies these rule objects to the path elements and adjusts the risk index values accordingly.

Input: Textual risk rules from Step 8 and road network plus incident attributes.

Output: Updated risk indices for each path element reflecting both statistical and rule-based risk, stored in the road risk data structure.

### Step 10:

The server generates candidate routes ignoring detailed risk at first. The server uses a routing engine to compute one or more shortest or fastest paths between the origin and destination provided in the request. The server obtains sequences of path elements representing these candidate routes and the associated base travel times.

Input: Origin and destination coordinates from Step 3, and current road network data.

Output: A set of candidate routes, each represented as an ordered list of path elements with base travel times.

### Step 11:

The server calculates combined cost for each candidate route by integrating the risk index.

The server retrieves risk indices for all path elements in the candidate routes, defines a cost function that sums base travel time and a risk penalty term, and computes a total cost for each route. The server may discard candidate routes whose total risk penalty exceeds a predefined threshold.

Input: Candidate routes from Step 10 and updated risk indices from Step 9.

Output: A filtered list of candidate routes annotated with combined cost values reflecting both time and risk.

### Step 12:

The server constructs a second prompt sentence for route selection and sends it to the generative AI model. The server converts attributes of the filtered candidate routes (such as length, travel time, maximum risk index, and types of streets used) into a concise textual description, embeds it into a second prompt sentence that asks the generative AI model to choose the most appropriate route, and submits it to the model.

Input: Filtered candidate route attributes from Step 11.

Output: A second prompt sentence summarizing candidate routes and asking for selection guidance.

### Step 13:

The server receives route evaluation and selection from the generative AI model. The server parses the model's textual output, which includes an identifier of the recommended route and evaluation comments explaining the choice. The server verifies that the chosen route meets predefined safety constraints and marks that route as the selected safe route.

Input: Text response from the generative AI model generated in response to the second prompt sentence.

Output: An identifier of the selected safe route and associated evaluation information.

### Step 14:

The server generates human-readable explanation information for the selected safe route. The server assembles data describing which high-risk streets were avoided and which safer paths were used, and constructs a third prompt sentence requesting a short explanation for the user, for example, “Create a short explanation of why this walking route is considered safe. The route avoids the following high-risk streets and uses the following safer streets.” The server sends this third prompt sentence to the generative AI model and receives a concise explanation in natural language.

Input: Selected route data from Step 13 and high-risk area details from previous steps.

Output: Explanation information describing reasons for the route's safety.

### Step 15:

The server prepares the response payload and sends it to the terminal. The server encodes the selected route as a set of coordinates or polylines, packages turn-by-turn instructions, the explanation text, and a risk summary into a response object, and transmits it to the terminal over the network.

Input: Selected route, explanation information from Step 14, and route geometry.

Output: A response message delivered to the terminal containing route geometry, instructions, and explanation text.

### Step 16:

The terminal renders the safe route and explanation to the user. The terminal decodes the route geometry, draws the path on a digital map, and displays origin and destination markers.

The terminal shows the explanation text in a user interface component and, if enabled, uses a text-to-speech engine to read it aloud. The terminal also highlights any nearby high-risk areas using different colors or icons.

Input: Response message from the server in Step 15.

Output: A visual and/or audio presentation of the selected safe route and its explanation to the user.

### Step 17:

The user travels along the suggested safe route while carrying the terminal. The user refers to the displayed guidance, follows turn-by-turn instructions, and adjusts movement based on real-time updates. The user may observe environmental conditions such as lighting or crowd levels, which later influence feedback.

Input: On-screen route guidance and optional voice instructions from the terminal.

Output: Physical movement of the user along the suggested route and observational experience of perceived safety.

### Step 18:

The terminal monitors the user's location relative to the selected route. The terminal periodically reads current coordinates from its location sensor, compares them to the planned route geometry, and determines whether the user remains on the route or has deviated from it. When a significant deviation is detected, the terminal sends the new current location and the route ID to the server to request a recalculated safe route.

Input: Current location samples from the terminal's position sensor and original route geometry.

Output: A deviation event and an updated route request transmitted to the server if deviation occurs.

### Step 19:

The server recalculates a route when deviation occurs. The server treats the new current location as a new origin, retains the original destination, and reuses the updated risk indices from earlier steps. The server computes new candidate routes from the new origin, recalculates combined costs incorporating risk, and optionally uses the generative AI model again to confirm or adjust the recommended route.

Input: Deviation event and new origin coordinates from Step 18, and existing risk indices.

Output: A newly computed safe route and, optionally, updated explanation information sent back to the terminal.

### Step 20:

The user provides feedback after completing the route. The user interacts with a feedback screen on the terminal, selects a safety rating, and enters a free-form comment describing perceptions, for example, “The area near the park felt darker than expected.” The user submits this feedback through the application.

Input: User safety rating and free-form comment entered via the terminal interface.

Output: A feedback payload stored temporarily in the terminal, prepared for transmission to the server.

### Step 21:

The terminal sends feedback data to the server. The terminal wraps the feedback into a JSON object including route ID, rating value, comment text, and timestamps, and sends this object to the server over the network.

Input: Feedback payload from Step 20.

Output: A feedback message transmitted to the server for analysis.

### Step 22:

The server stores and aggregates feedback. The server parses the feedback message, associates it with the corresponding path elements and route record, and stores it in a feedback table. The server periodically aggregates feedback for each path element, calculating average ratings and counting negative or positive reports.

Input: Feedback messages from Step 21 and stored route/path mappings.

Output: Aggregated feedback metrics per path element stored in the database.

### Step 23:

The server applies natural language processing to free-form feedback. The server uses a language processing library to tokenize comments, detect sentiment, and extract key phrases related to safety, such as “poor lighting” or “few people around.” The server creates structured representations that link phrases and sentiment scores to specific path elements and time contexts.

Input: Free-form comment texts and their associated path elements from Step 22.

Output: Structured feedback features describing sentiment and safety-related phrases mapped to path elements.

### Step 24:

The server constructs a fourth prompt sentence to update risk indices using feedback and sends it to the generative AI model. The server summarizes aggregated feedback features, current risk indices, and incident statistics, and embeds them into a fourth prompt sentence requesting adjustments to risk scores, for example, “Here are road segments with current risk scores, recent crime data, and user feedback comments with sentiments. Suggest how to adjust the risk scores and summarize the reasons.” The server sends this prompt sentence to the generative AI model.

Input: Aggregated feedback features, current risk indices, and incident statistics from earlier steps.

Output: A fourth prompt sentence that instructs the generative AI model to propose risk index updates.

### Step 25:

The server receives risk adjustment suggestions and updates the risk indices. The server parses the text response from the generative AI model, extracts proposed adjustments for the risk indices of specific path elements, and verifies that the adjustments conform to allowed ranges. The server then updates the risk indices in the road risk data structure.

Input: Text response from the generative AI model in reply to the fourth prompt sentence.

Output: Revised risk indices stored in the database, which influence future route computations.

### Step 26:

The server thereby maintains an adaptive, risk-aware routing model. The server combines updated risk indices with future spatiotemporal data and routing requests, leading to improved safety estimation and route recommendations over time. The server's iterative updates reduce the likelihood of repeatedly suggesting routes that users perceive as unsafe and improve the overall quality and responsiveness of the system.

Input: Revised risk indices from Step 25 and new incident and feedback data arriving over time.

Output: An evolving internal state of the routing and risk model that is used for subsequent safe route computations and explanations.

### Application Example 2

Description follows regarding a flow of the specific processing in an Application Example 2. The units of the system described below are implemented by the data processing device 12 and the smart device 14. The data processing device 12 is called a “server” and the smart device 14 is called a “terminal”.

Conventional route guidance and safety-information systems generally rely on static scoring rules and precomputed hazard layers. Such systems typically combine map data with incident statistics in a fixed manner and then display simple overlays on a client device. As a result, these systems exhibit several technical limitations when implemented on general-purpose computer hardware.

First, existing systems often perform route risk evaluation independently of a user's real-time emotional state. The processing pipeline executed by a processor does not dynamically adapt weighting parameters, data aggregation logic, or path-selection algorithms in response to changing user conditions such as anxiety or risk aversion. This leads to a technically sub-optimal use of computing resources in that the same computation is repeatedly executed with uniform parameters, even when the underlying risk-tolerance profile of the user differs substantially. The lack of emotion-aware adjustment also forces application developers to implement complex, ad-hoc logic on the client, which increases CPU load, memory consumption, and network traffic on resource-constrained user terminals.

Second, conventional systems do not integrate generative artificial intelligence models into the core route-evaluation loop in a structured, machine-oriented way. In many cases, a generative AI model is accessed, if at all, via ad-hoc textual queries crafted manually on the client side. The processor does not systematically generate prompt sentences from structured context data, such as per-segment risk scores, event distributions, and emotion states, nor does it reuse such structured prompts for multiple inference cycles. As a consequence, the data path between numerical computation modules and natural-language generation modules remains fragmented, which causes redundant data conversions, increased latency due to separate API calls, and inconsistent explanations that are difficult to cache or compress at the server.

Third, when a user deviates from a recommended route or when new high-risk events occur, existing implementations frequently recompute routes and generate explanations in a naive, full-recalculation manner. In these implementations, the processor re-evaluates all possible paths from scratch and rebuilds human-readable messages independently of previously computed intermediate results. This can cause unnecessary repetition of geospatial queries, re-encoding of map data, and repeated construction of large prompt texts to the generative AI model, thereby increasing processing time, memory footprint, and network utilization in server-side computing environments. The user terminal may experience delayed updates or jittery route rendering, resulting from bursty server responses and non-deterministic response sizes from the generative AI model.

Fourth, at an area-analysis level, traditional systems typically compute static heatmaps or simple statistics from crime incident datasets without jointly analyzing user-provided emotion-related information. These systems do not provide an integrated pipeline in which a processor aggregates event information and emotion-related information over multiple regions and time periods, computes region-level safety indices, and then generates machine-optimized prompt sentences for a generative AI model. Consequently, backend computing components cannot exploit the expressive power of a generative AI model to generate structured, adaptive recommendations for regional countermeasures, and system maintainers must manually author textual reports or rely on rigid templates, which are costly to maintain and difficult to tailor to varying data distributions.

Accordingly, there is a need for an improved computer-implemented system and method in which a processor, operating in cooperation with a communication interface, is configured to: (i) acquire and integrate location information, event information, and emotion-related information; (ii) compute and dynamically adjust route-level safety evaluation values based on an emotional state; (iii) generate structured context information and prompt sentences for a generative AI model; and (iv) obtain and deliver consistent, low-latency natural-language response information to user terminals, both for individual route guidance and for regional safety analysis. Such a system should improve the efficiency and technical performance of server-side route computation, risk evaluation, prompt generation, and explanation delivery, thereby enhancing throughput, reducing redundant processing, and stabilizing response behavior compared with prior approaches.

The specific processing by the specific processing unit 290 of the data processing device 12 in Application Example 2 is realized by the following means.

The present invention provides a server comprising a processor and a communication interface, the processor being configured to acquire, via the communication interface, location information and user input information from a user terminal; to acquire, on the basis of the location information, a plurality of movement route candidates including a departure point and an arrival point; to acquire, from an external information source, event information relating to an area including the movement route candidates; to aggregate the event information in association with the movement route candidates and calculate, for each of the movement route candidates, an evaluation value indicating a safety level of the corresponding movement route candidate; to analyze emotion-related information included in the user input information to specify an emotional state of a user; to change calculation conditions of the evaluation value in accordance with the emotional state and re-evaluate the movement route candidates so as to specify a recommended route; to generate context information including the recommended route, the event information, and the emotional state as explanation information, and generate a prompt sentence to be input to a generative AI model on the basis of the context information; to input the prompt sentence to the generative AI model and acquire response information from the generative AI model; and to provide the recommended route and the response information to the user terminal via the communication interface. This enables the server to perform emotion-adaptive route scoring and structured prompt generation on the server side, to efficiently integrate numerical risk computation with natural-language explanation, to reduce redundant recalculation and client-side processing, and to deliver consistent, low-latency safety guidance and regional countermeasure proposals, thereby improving the overall technical performance of computer-implemented route guidance and safety analysis.

The term “system” refers to a combination of one or more hardware units, software modules, communication interfaces, and data storage components that cooperate to execute the processing described in the claims.

The term “processor” refers to one or more processing circuits, such as a central processing unit, a graphics processing unit, a digital signal processor, or any other programmable logic device, configured to execute instructions for performing the claimed functions.

The term “communication interface” refers to hardware and software components that enable data exchange between the processor and external devices or networks, including wired and wireless interfaces such as network controllers, transceivers, and communication stacks.

The term “user terminal” refers to any information processing device operated by a user, such as a mobile telephone, a tablet device, a portable computer, or an in-vehicle device, that is capable of sending information to and receiving information from the system.

The term “location information” refers to data indicating a geographic position, such as latitude, longitude, altitude, or similar positional coordinates, optionally including accuracy, timestamp, and movement direction.

The term “user input information” refers to data provided directly or indirectly by a user through the user terminal, including text, selections, sensor-based inputs, voice inputs, or other signals that express user intentions, preferences, or conditions.

The term “movement route candidate” refers to data representing a possible path between at least a departure point and an arrival point, including a sequence of geographic points, segments, or links that can be traversed by the user.

The term “departure point” refers to location information indicating a starting position of a movement route candidate.

The term “arrival point” refers to location information indicating an end position of a movement route candidate.

The term “external information source” refers to any data provider outside the system, including remote databases, web services, sensor networks, or public data platforms, from which event information or related data can be obtained.

The term “event information” refers to data describing incidents or occurrences associated with specific geographic locations and times, such as safety-related incidents, environmental conditions, or other events relevant to evaluating risk or safety.

The term “evaluation value” refers to a numerical or categorical indicator computed by the processor that represents a safety level or other quality metric of a movement route candidate.

The term “safety level” refers to a relative degree of risk or protection associated with a movement route candidate, derived from event information and optionally other contextual factors.

The term “emotion-related information” refers to any data from which an emotional condition of a user can be inferred, including text content, voice characteristics, image-based expressions, selections, or explicit self-reports.

The term “emotional state” refers to an estimated psychological condition of a user, such as anxiety, calmness, fear, confidence, or similar affective attributes, determined on the basis of emotion-related information.

The term “recommended route” refers to at least one movement route candidate selected by the processor on the basis of one or more evaluation values and optionally the emotional state of the user.

The term “context information” refers to structured or semi-structured data that summarizes relevant information, including at least the recommended route, associated event information, and the emotional state, for use in generating a prompt sentence.

The term “prompt sentence” refers to text or text-equivalent data generated by the processor that is formatted for input to a generative AI model and that instructs the generative AI model to produce response information based on the context information.

The term “generative AI model” refers to a machine learning model configured to generate text, symbols, or other data in response to an input prompt, using learned parameters derived from training data.

The term “response information” refers to output data generated by the generative AI model in response to a prompt sentence, including explanations, recommendations, or other natural-language or structured information.

The term “safe movement route” refers to a recommended route that has been selected at least in part based on a safety-oriented evaluation value indicating a reduced level of risk compared to other movement route candidates.

The term “deviation” refers to a state in which current location information of the user differs from a predetermined spatial tolerance around the recommended route.

The term “update prompt sentence” refers to a prompt sentence generated in response to a recalculation of a recommended route or to a change in conditions, and intended to cause the generative AI model to output updated response information.

The term “update response information” refers to response information that is generated by the generative AI model based on an update prompt sentence and that explains or supports a recalculated recommended route.

The term “region” refers to a geographic area defined by boundaries, such as administrative districts, grid cells, or zones, within which event information and emotion-related information are aggregated.

The term “time period” refers to a defined interval of time, such as an hour, a day, or a week, used as a unit for aggregating or analyzing event information and emotion-related information.

The term “safety index” refers to a calculated value that quantifies a relative safety condition of a region for a particular time period or overall, based on aggregated event information and emotion-related information.

The term “analysis context information” refers to context information prepared for regional or aggregate analysis, including safety indices, aggregated event distributions, emotion distributions, and one or more candidate countermeasures.

The term “countermeasure contents” refers to information indicating recommended actions, measures, or policies to be implemented in a region to improve safety or reduce risk.

In one embodiment, a server cooperates with one or more terminals operated by users to provide emotion-adaptive, safety-oriented route guidance and regional safety analysis. The server includes at least one processor, a memory storing executable instructions and data structures, a communication interface for network access, and a non-transitory storage device for persisting models and historical data. The terminal includes a processor, a display, an input interface such as a touch panel and microphone, a positioning device such as a GPS receiver, and a communication interface such as a wireless transceiver.

The server executes an application implemented, for example, using a web application framework written in a general-purpose programming language such as Python. The server uses a geographic information service, such as a map service API, to obtain digital road network data and route candidates. The server uses network communication libraries, such as an HTTP client library, to retrieve incident and event data from external open-data APIs and from safety-related databases. The server uses a data analysis library, such as Pandas, and a numerical computation library, such as NumPy, to process tabular event information, and may use a geospatial library, such as a geometry library, to perform geometric operations on route segments and event locations.

The server stores movement route candidates as graph-structured data in memory. In one configuration, the server represents each route candidate as a sequence of nodes, where each node stores at least latitude, longitude, and an index into the underlying road network, and as a sequence of edges, where each edge stores a length, a travel time estimate, and references to adjacent nodes. The server converts compressed polyline representations obtained from the map service API into this explicit node-edge representation, which enables efficient segment-level association of event information. This graph representation differs from conventional purely visual overlays and is used internally for numerical risk evaluation and for prompt construction.

The server stores event information received from external data sources in a structured format, such as a table that includes fields for event type, occurrence time, geographic coordinates, severity level, and data source identifier. The server uses indexing structures, such as spatial indices or hash maps keyed by grid cell and time interval, to group events by region and time period. By using these indices, the server reduces the number of distance computations required when matching events to route segments, thereby improving processing speed and reducing processor load compared to naive linear scanning.

The terminal acquires user input information and location information by hardware components. The terminal detects its position using its GPS receiver and, optionally, other location services such as Wi-Fi-based positioning and inertial sensors. The terminal converts user-entered addresses or map taps into coordinates via a geocoding service. The terminal accepts text input expressing user concerns or intentions, such as “I feel a bit unsafe walking here at night,” and may capture voice signals or images showing a user's face. The terminal transmits this location information and user input information to the server via its communication interface.

The server derives emotion-related information from the raw user input information. In one embodiment, the server uses a text-based emotion classifier implemented as a neural network model. The server represents each token of the user's text as an embedding vector and feeds a sequence of embeddings into a neural architecture such as a bidirectional recurrent neural network or a transformer-type encoder. The server computes attention-weighted hidden states and passes an aggregated representation through one or more fully connected layers with nonlinear activation functions to produce a distribution over emotion categories, for example “anxious,” “calm,” “afraid,” or “confident,” as well as a continuous score indicating strength of each category. The server stores these scores as the user's emotional state.

The server trains the emotion classifier in advance using supervised learning. During training, the server minimizes a loss function such as cross-entropy loss between predicted emotion distributions and ground-truth labels, and updates model parameters by gradient-based optimization, such as stochastic gradient descent or an adaptive variant. The server may apply data augmentation techniques such as synonym replacement or back-translation on training sentences in order to improve robustness. By explicitly disclosing these model structures and training methods, the emotion classification is not treated as a black-box step but as a concrete algorithm that transforms text into emotion-state vectors.

The server computes evaluation values for each movement route candidate by combining event information with an emotional state. In one implementation, the server defines a feature vector for each route segment. The server includes, as components of this feature vector, counts of events by type (for example, thefts, assaults), recentness of events (for example, exponentially decayed based on elapsed time), time-of-day factors, and region-level background indices. The server further includes in the feature vector indicators derived from the emotional state, such as a binary or continuous anxiety coefficient.

The server computes a risk score per segment as a dot product between the feature vector and a weight vector that has been determined by offline training. Training may use a logistic regression or a shallow neural network on historical data where segments are labeled with incident occurrence outcomes or user feedback regarding perceived safety. Training uses a loss function such as binary cross-entropy, and the server updates weights using a gradient-based optimizer. The server stores the learned weights in memory and in persistent storage. At runtime, when the emotional state changes, the server modifies selected elements of the weight vector, such as increasing the weight assigned to night-time incidents when the user is anxious, or decreasing the weight assigned to minor property crimes when the user expresses a higher tolerance. Because these adjustments are algebraic operations applied to the weight vector before computing dot products, the server can rapidly recalculate the evaluation values without recomputing all underlying statistics.

The server computes an evaluation value for each movement route candidate by summing or otherwise aggregating segment-level risk scores and normalizing by route length and travel time. The server then selects at least one recommended route by applying a selection rule, such as choosing the minimal evaluation value subject to a maximum detour constraint. This selection rule is implemented as a computation over the route graph rather than as a mere visual overlay, thus improving consistency and allowing incremental updates when new events or new location data arrive.

The server generates context information for use with a generative AI model by combining structured route and event data with the emotional state. The server constructs a data object including at least: identifiers for the recommended route, summary statistics such as total risk score and length, lists of segments with elevated risk, and the categorized emotional state.

The server compresses route geometry into a simplified representation for explanation purposes, such as by grouping consecutive segments into logical legs. The server associates with each leg a summary of nearby event types and time-of-day patterns. This structured context reduces the amount of raw data that must be converted to text for each call to the generative AI model, reducing communication payload size and latency.

The server converts the context information into a prompt sentence for the generative AI model. The server uses a template engine or a dedicated formatting module to embed the context into a standardized textual pattern. For example, the server may generate a prompt sentence such as:

“Given the following route from the user's current location to the destination, the per-segment crime risk scores, and the fact that the user feels anxious at night, generate a concise English explanation of why this route is recommended, which crime risks it avoids, and how it supports an anxious user.”

The server may generate alternative prompt sentences for regional analysis, such as:

“Using the following crime time-series and user emotion feedback for district X over the last 3 months, generate a detailed yet accessible report that highlights high-risk zones, peak crime hours, and recommended community-level prevention measures.”

By consistently forming prompt sentences from structured context, the server reduces redundancy in the prompt generation process and facilitates caching strategies, which in turn lower average response time and bandwidth use.

The server connects to a generative AI model via an inference interface. In one embodiment, the generative AI model is a transformer-based language model deployed on a remote inference service. The server sends the prompt sentence along with optional configuration parameters, such as maximum token count and decoding temperature, over an encrypted network channel. The server receives response information in the form of generated text. The server may apply post-processing rules, such as enforcing a maximum character length, removing disallowed terms, or segmenting the text into bullet-like sentences, to fit the design constraints of the terminal interface.

The terminal receives the recommended route and response information from the server. The terminal decodes any compressed route representation and draws the route on a map display using a map rendering component. The terminal highlights higher-risk legs with distinct colors or icons, based on per-segment evaluation values provided by the server. The terminal displays the generated explanation text in a dedicated panel, and may use its text-to-speech engine to read the explanation aloud. In this manner, the system controls the behavior of concrete hardware elements, including the display and audio output devices, to guide the user's physical movement in the real world along safer paths.

The server reduces computation and communication load during route updates by performing incremental recalculation. When the terminal transmits new location information indicating that the user has deviated from the recommended route, the server identifies the nearest node in the internal route graph and restricts recalculation to a sub-graph around the user's current position. The server reuses previously computed evaluation values for unchanged segments and only recomputes scores for segments newly included in candidate routes or for segments affected by newly arrived event information. Because the evaluation values depend on separable feature vectors and weight vectors, this incremental recalculation can be implemented as matrix operations over a subset of segments, which improves throughput relative to full recomputation.

The server also reduces the number and size of generative AI model calls. For small deviations where the overall risk profile has not materially changed, the server may generate a shorter update prompt sentence, such as:

“Explain briefly why the route has been updated due to newly detected nearby incidents, and reassure an anxious user that the new route maintains a low crime risk.”

By using shorter prompts and simpler context summaries for minor updates, the server shortens the generative AI processing time and reduces network traffic, which is particularly advantageous in mobile network environments with limited bandwidth.

The server performs regional aggregation of event information and emotion-related information for long-term analysis. The server divides a geographic area into regions, such as grid cells or administrative districts, and partitions time into intervals. For each region and time interval, the server accumulates counts and weighted counts of different event types, and aggregates emotion-related signals, such as average anxiety scores from users who reported feelings in that region. The server computes a safety index for each region, for example by applying a function that combines normalized incident densities and normalized emotion indicators.

The server stores these safety indices and aggregated statistics, and uses them to generate analysis context information. The server then constructs prompt sentences tailored for planning countermeasures, such as:

“Given these crime hot spots, incident types, and residents' reported anxiety levels, propose concrete preventative actions a city and local community can implement during the next month.”

The server sends such prompt sentences to the generative AI model and receives detailed suggestions. The server presents the countermeasure contents via terminals used by administrators or community leaders. By mechanizing this combination of numerical aggregation and generative reporting, the server improves the reuse of data, reduces manual report drafting overhead, and supports more frequent updates without a corresponding increase in human workload.

The system provides several technical effects that go beyond mere automation of human tasks. By using an internal graph-based route representation, indexed event storage, and feature-vector-based risk scoring, the server improves computational efficiency and allows incremental recalculation when conditions change, which increases processing throughput and lowers latency on typical server hardware. By adjusting risk evaluation based on emotion-derived parameters at the weight-vector level, the server avoids recomputing raw statistical aggregates while still changing behavior, thereby improving computational efficiency without sacrificing personalization. By structuring context information and generating standardized prompt sentences, the server reduces redundancy in prompt construction, minimizes data transmitted to the generative AI model, and stabilizes response size, which collectively reduce communication load and decrease variability in response time.

The system also improves the technical functioning of the generative AI integration. In typical deployments, free-form prompts cause inconsistent outputs and hamper caching. In contrast, the disclosed server defines specific data structures for context information and enforces deterministic prompt templates, which allows the server to detect repeated contexts and reuse cached response information. This caching reduces the number of calls to remote inference services and lowers both latency and computational cost across the system.

The system departs from conventional rule-based route selection by incorporating user emotional state into the route evaluation function in a mathematically explicit way. The server does not merely perform a logical “if anxious then choose well-lit street” rule; instead, the server modifies continuous weight vectors and recomputes numeric evaluation values, enabling more nuanced control and smoother adaptation to intermediate emotional states.

This distinctive integration of emotion scores into a numeric optimization framework is not a simple translation of human intuition but rather an algorithmic enhancement that leverages machine-measured signals to adjust computational behavior.

Alternative embodiments are also possible. The server may use a different model architecture for the emotion classifier, such as a convolutional neural network over character sequences, or may employ a hybrid model that combines rule-based filters with neural outputs. The server may substitute different optimization algorithms or loss functions, such as hinge loss for margin-based classification, or may extend the feature vector to include environmental sensor data, such as illumination levels or traffic density. The generative AI model may be hosted locally within the server's infrastructure rather than accessed via a remote service, in which case the server can control batch sizes and scheduling, further optimizing hardware utilization. The system may operate in a distributed configuration where multiple servers share a common event database and synchronize model parameters periodically.

In each embodiment, the server, the terminal, and the user cooperate so that the server performs concrete data transformations and control actions over hardware components. The server processes sensor-derived location information and externally sourced event information, transforms these into route graphs and evaluation values, generates prompt sentences for a generative AI model, and returns both optimized route data and natural-language explanations to terminals. The terminals use these outputs to drive displays, speakers, and navigation functions, enabling users to move in the physical world along routes that are dynamically adapted to their emotional state and to changing safety conditions, with improved computational efficiency and technical robustness compared with conventional systems.

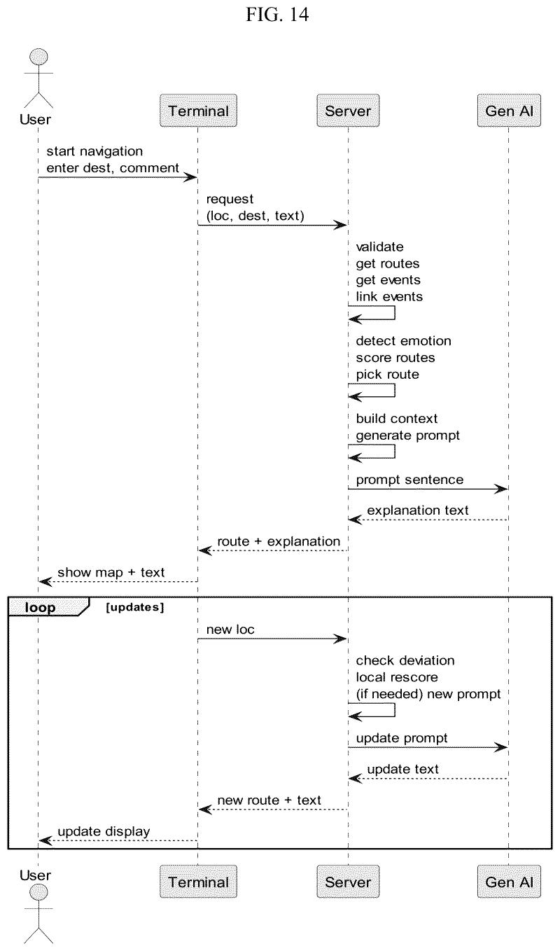

The following describes the processing flow using FIG. 14.

### Step 1:

User operates the terminal to start a safety-aware navigation function and to provide initial input.

User selects a destination on a map or enters an address as text and optionally enters a text comment such as “I feel anxious walking here at night.”

Input: user's textual address or map selection, optional free-text comment, and an initial GPS-based current location.

Terminal converts the textual address into geographic coordinates via a geocoding service and packages the coordinates, the current location, the timestamp, and the user comment into a request object.

Terminal outputs: a structured request containing departure coordinates, destination coordinates, timestamp, and user input text.

### Step 2:

Terminal transmits the structured request to the server via a communication interface.

Input: the structured request from Step 1.

Terminal serializes the request as JSON, establishes an HTTPS connection, and sends the JSON payload to a predefined endpoint of the server.

Terminal outputs: an HTTP request containing the JSON payload to the server.

### Step 3:

Server receives the HTTP request and validates the request parameters.

Input: the HTTP request with JSON body from Step 2.

Server parses the JSON body, checks that the departure and destination coordinates are within supported geographic bounds, and verifies that a timestamp and mode flag (for example, “route guidance”) are present or assigns defaults.

Server rejects malformed requests or logs warnings and proceeds only with a valid request. Server outputs: a validated request object in memory containing coordinates, timestamp, and user text.

### Step 4:

Server acquires movement route candidates using a map service API.

Input: validated departure and destination coordinates from Step 3.

Server sends a directions query to a map service API, requesting multiple alternative routes; the server receives route polylines, per-step distances, and estimated travel times. Server decodes each polyline into an ordered list of latitude-longitude pairs and constructs a graph representation where each edge stores distance and travel time.

Server outputs: a set of route candidate graphs stored in memory.

### Step 5:

Server acquires event information for an area covering the route candidates.

Input: bounding box or corridor derived from the route candidate graphs of Step 4. Server calls one or more external event data APIs, specifying spatial and temporal filters, and downloads incident records in JSON or CSV format.

Server normalizes the records into a tabular structure with fields such as event type, time, coordinates, and severity level; the server discards records with invalid coordinates or missing critical fields.

Server outputs: a cleaned event information table indexed by time and region.

### Step 6:

Server associates event information with route segments and computes segment-level features.

Input: route candidate graphs from Step 4 and event table from Step 5.

Server determines, for each route segment, nearby events by calculating distances between segment midpoints and event coordinates and applying a distance threshold or spatial index lookup.

Server counts events per type and applies time-decay functions to emphasize recent events; the server stores these statistics as feature values attached to each segment. Server outputs: route candidate graphs enriched with segment-level feature vectors that summarize local event risk.

### Step 7:

Server derives emotion-related information and emotional state from user input.

Input: user text comment from Step 3.

Server tokenizes the text, maps each token to an embedding vector, and feeds the sequence into a trained neural network emotion classifier; the server computes hidden activations and applies a final softmax layer to obtain probabilities for emotion categories.

Server designates an emotional state, such as “anxious” with an associated intensity score, based on the highest probability and related values.

Server outputs: an emotional state descriptor and an emotion intensity score for the user.

### Step 8:

Server computes evaluation values for each movement route candidate using event features and emotional state.

Input: enriched route graphs from Step 6 and emotional state from Step 7.

Server constructs, for each segment, a feature vector including event counts, time-decay values, and region background risk indicators and augments the vector with a coefficient derived from the emotion intensity (for example, scaling factors for night-time incidents when anxiety is high).

Server multiplies the feature vector by a learned weight vector and sums the result to obtain a risk score per segment; the server then aggregates segment scores along each route and normalizes by route length and travel time to obtain route-level evaluation values.

Server outputs: a set of evaluation values, one for each movement route candidate.

### Step 9:

Server selects a recommended route based on evaluation values and movement constraints.

Input: evaluation values from Step 8 and the corresponding route candidate graphs.

Server compares the evaluation values, discards candidates exceeding a predefined maximum detour or travel time threshold, and chooses the candidate with the lowest remaining evaluation value as the recommended route.

Server may also rank secondary candidates and store them for potential future re-routing.

Server outputs: a recommended route graph and optional ranked alternative routes.

### Step 10:

Server generates context information describing the recommended route, event information, and emotional state.

Input: recommended route from Step 9, event table from Step 5, and emotional state from Step 7.

Server summarizes the recommended route into legs, associates each leg with nearby event statistics, aggregates total risk scores, and records the emotional state label and intensity.

Server structures this summary into a context object that can be converted into text, including fields for route length, travel time, primary risks avoided, and user emotional condition.

Server outputs: a context information object suitable for generating a prompt sentence.

### Step 11:

Server generates a prompt sentence for a generative AI model based on the context information.

Input: context information from Step 10.

Server applies a template that inserts numerical values and categorized data into a human-readable instruction, for example:

“Given the following route from the user's current location to the destination, the per-segment crime risk scores, and the fact that the user feels anxious at night, generate a concise English explanation of why this route is recommended, which crime risks it avoids, and how it supports an anxious user.”

Server may also generate different prompt sentences for regional analysis or update events using other templates.

Server outputs: a prompt sentence string to be supplied to a generative AI model.

### Step 12:

Server calls the generative AI model with the prompt sentence and acquires response information.

Input: prompt sentence from Step 11.

Server sends the prompt sentence to a generative AI model endpoint via an API, specifying decoding parameters such as maximum output length and sampling strategy; the server waits for an inference result.

Server receives generated text, which describes the reasons for recommending the route and suggests safety considerations, and optionally normalizes the style or truncates overly long responses.

Server outputs: response information in textual form suitable for presentation to the user.

### Step 13:

Server constructs a final response object for delivery to the terminal.

Input: recommended route from Step 9 and response information from Step 12.

Server encodes the route geometry into a compact representation, such as polyline encoding, and packages it together with step-by-step navigation instructions, per-segment risk annotations, and the generated explanation text.

Server serializes this data into a JSON structure to minimize size and facilitate parsing on the terminal side.

Server outputs: a structured response object sent as an HTTP response to the terminal.

### Step 14:

Terminal receives the response object and renders the route and explanation to the user.

Input: structured response object from Step 13.

Terminal decodes the route geometry, draws the recommended route on the map display, overlays markers or color-coded segments to indicate relative risk, and presents the explanation text in a panel or popup.

Terminal may additionally invoke a text-to-speech engine to vocalize the explanation, making the guidance accessible while the user is walking or driving.

Terminal outputs: visual and audio outputs that guide the user along the recommended route.

### Step 15:

Terminal monitors real-time location and reports deviations or updates to the server.

Input: continuous GPS readings during user movement.

Terminal compares the current location to the recommended route corridor; when the position exceeds a deviation threshold or when a periodic update interval elapses, the terminal sends the new location to the server along with a session identifier.

Terminal outputs: an update request containing the latest location information and route session context.

### Step 16:

Server performs incremental re-evaluation of routes and, if needed, generates an update prompt sentence.

Input: update request from Step 15, existing recommended route, evaluation values, and recent event information.

Server identifies the nearest route node to the new location, determines whether the user has deviated into a higher-risk area, and if so, limits recalculation to local segments around the new position while reusing stored evaluation values for unaffected segments.

Server, upon detecting a route change, generates a shorter update prompt sentence, such as: “Explain briefly why the route has been updated due to newly detected nearby incidents, and reassure an anxious user that the new route maintains a low crime risk.”

Server then calls the generative AI model with this update prompt sentence and obtains concise update response information.

Server outputs: an updated recommended route, if necessary, and updated response information.

### Step 17:

Terminal updates the displayed route and explanation based on the server's incremental re-evaluation.

Input: updated recommended route and updated response information from Step 16. Terminal redraws the route on the map, optionally animates the change to highlight the adjustment, and replaces or augments the displayed explanation with the updated text. Terminal may issue an audio alert notifying the user that a safer route has been selected due to new conditions.

Terminal outputs: revised visual and audio guidance that reflects the latest safety evaluation and generative AI explanation.

The data generation model 58 is a so-called generative artificial intelligence (AI). Examples of the data generation model 58 include generative Als such as ChatGPT (registered trademark) (Internet search <URL: https://openai.com/blog/chatgpt>) and the like.

The data generation model 58 is obtained by performing deep learning with a neural network.

The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Moreover, although the processing by the data processing system 10 described above was executed by the specific processing unit 290 of the data processing device 12 or by the control unit 46A of the smart device 14, the processing may be executed by a specific processing unit 290 of the data processing device 12 and a control unit 46A of the smart device 14. Moreover, the specific processing unit 290 of the data processing device 12 acquires and collects information needed for processing from the smart device 14 or from an external device or the like, and the smart device 14 acquires and collects information needed for processing from the data processing device 12 or from an external device or the like.

For example, a collection unit is implemented by the control unit 46A of the smart device 14 and/or by the specific processing unit 290 of the data processing device 12. For example, an acquisition unit acquires number-of-steps data using the camera 42 and/or the communication I/F 44 of the smart device 14, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the output device 40 of the smart device 14 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart device 14.

### Second Exemplary Embodiment

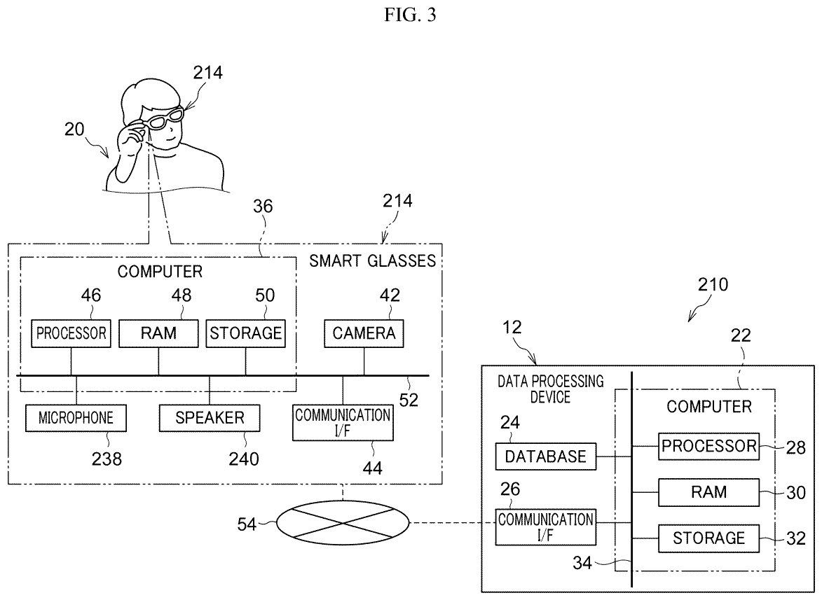

FIG. 3 illustrates an example of a configuration of a data processing system 210 according to a second exemplary embodiment.

As illustrated in FIG. 3, the data processing system 210 includes a data processing device 12 and smart glasses 214. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart glasses 214 include a computer 36, a microphone 238, a speaker 240, a camera 42, and a communication I/F 44. The computer 36 includes a processor 46, RAM 48, and storage 50. The processor 46, the RAM 48, and the storage 50 are connected to a bus 52. The microphone 238, the speaker 240, the camera 42, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

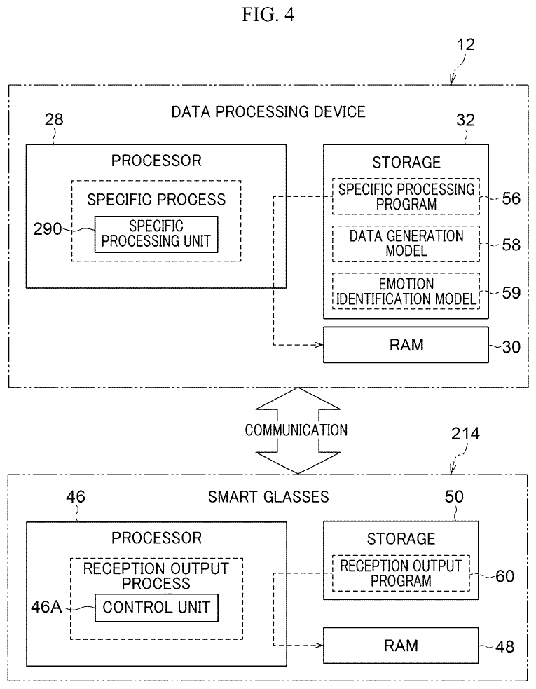

FIG. 4 illustrates an example of relevant functions of the data processing device 12 and the smart glasses 214. As illustrated in FIG. 4, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart glasses 214. A reception and output program 60 is stored in the storage 50. The processor 46 reads the reception and output program 60 from the storage 50 and in the RAM 48 executes the read reception and output program 60. The reception and output processing is implemented by the processor 46 operating as the control unit 46A according to the reception and output program 60 executed in the RAM 48. Note that a configuration may be adopted in which the smart glasses 214 include a data generation model and an emotion identification model similar to the data generation model 58 and the emotion identification model 59, and processing similar to the specific processing unit 290 is performed using these models.

Next, description follows regarding the specific processing by the specific processing unit 290 of the data processing device 12. The units of the system described below are implemented by the data processing device 12 and the smart glasses 214. In the following description the data processing device 12 is called a “server”, and the smart glasses 214 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the smart glasses 214. The control unit 46A in the smart glasses 214 outputs the specific processing result to the speaker 240. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative Als such as ChatGPT (registered trademark) (Internet search <URL: https://openai.com/blog/chatgpt>) and the like.

The data generation model 58 is obtained by performing deep learning with a neural network.

The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the smart glasses 214, the processing may be executed by a specific processing unit 290 of the data processing device 12 and a control unit 46A of the smart glasses 214. Moreover, the specific processing unit 290 of the data processing device 12 acquires and collects information needed for processing from the smart glasses 214 or from an external device or the like, and the smart glasses 214 acquires and collects information needed for processing from the data processing device 12 or from an external device or the like.

For example, the collection unit is implemented by the control unit 46A of the smart glasses 214 and/or by the specific processing unit 290 of the data processing device 12. For example, an acquisition unit acquires number-of-steps data using the camera 42 and/or the communication I/F 44 of the smart glasses 214, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 of the smart glasses 214 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart glasses 214.

### Third Exemplary Embodiment

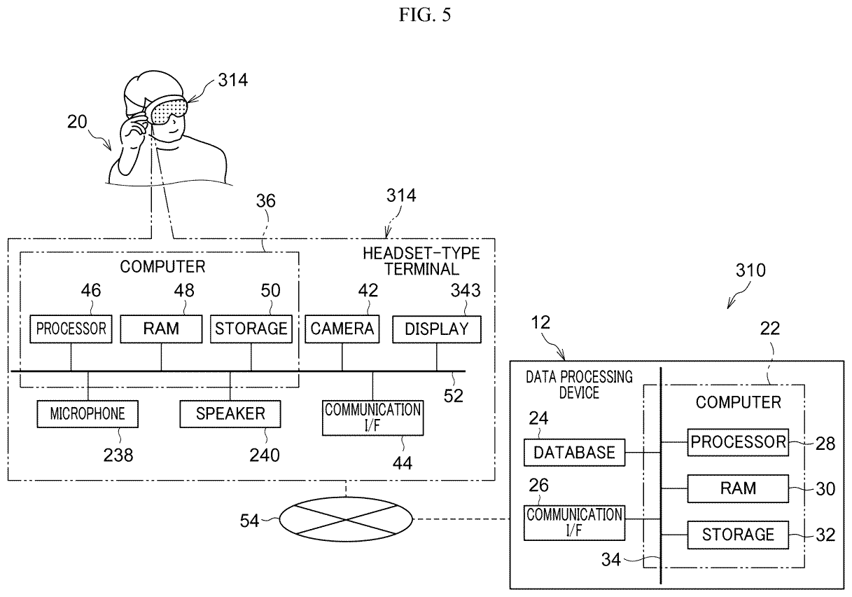

FIG. 5 illustrates an example of a configuration of a data processing system 310 according to a third exemplary embodiment.

As illustrated in FIG. 5, the data processing system 310 includes a data processing device 12 and a headset-type terminal 314. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The headset-type terminal 314 includes a computer 36, a microphone 238, a speaker 240, a camera 42, a communication I/F 44, and a display 343. The computer 36 includes a processor 46, RAM 48, and storage 50. The processor 46, the RAM 48, and the storage 50 are connected to a bus 52. The microphone 238, the speaker 240, the camera 42, the display 343, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

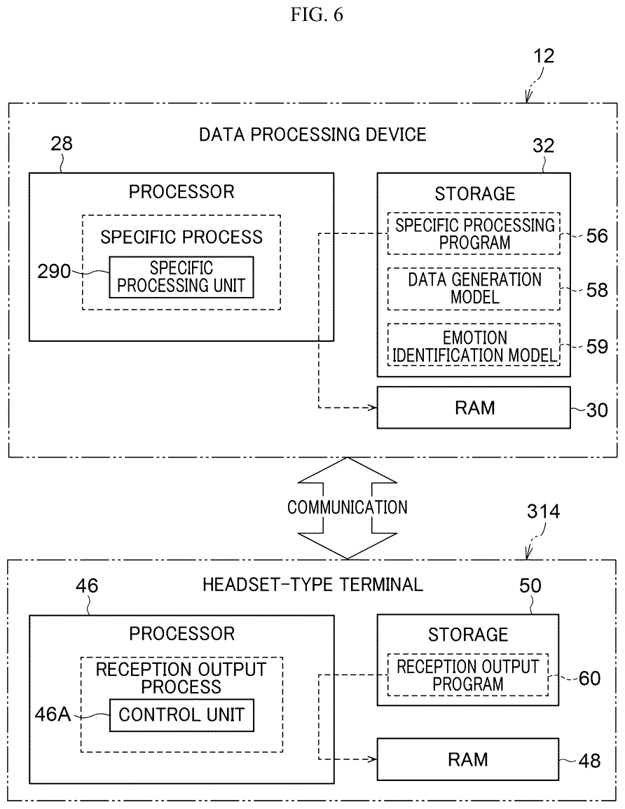

FIG. 6 illustrates an example of relevant functions of the data processing device 12 and the headset-type terminal 314. As illustrated in FIG. 6, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the headset-type terminal 314. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the headset-type terminal 314. In the following description the data processing device 12 is called a “server”, and the headset-type terminal 314 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the headset-type terminal 314. In the headset-type terminal 314, the control unit 46A outputs the result of the specific processing to the speaker 240 and the display 343. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative Als such as ChatGPT (registered trademark) (Internet search <URL: https://openai.com/blog/chatgpt>) and the like.

The data generation model 58 is obtained by performing deep learning with a neural network.

The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the headset-type terminal 314, the processing may be executed by a specific processing unit 290 of the data processing device 12 and a control unit 46A of the headset-type terminal 314. Moreover, the specific processing unit 290 of the data processing device 12 acquires and collects information needed for processing from the headset-type terminal 314 or from an external device or the like, and the headset-type terminal 314 acquires and collects information needed for processing from the data processing device 12 or from an external device or the like.

For example, the collection unit is implemented by the control unit 46A of the headset-type terminal 314 and/or by the specific processing unit 290 of the data processing device 12. For example, an acquisition unit acquires number-of-steps data using the camera 42 and/or the communication I/F 44 of the headset-type terminal 314, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the display 343 of the headset-type terminal 314 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the headset-type terminal 314.

### Fourth Exemplary Embodiment

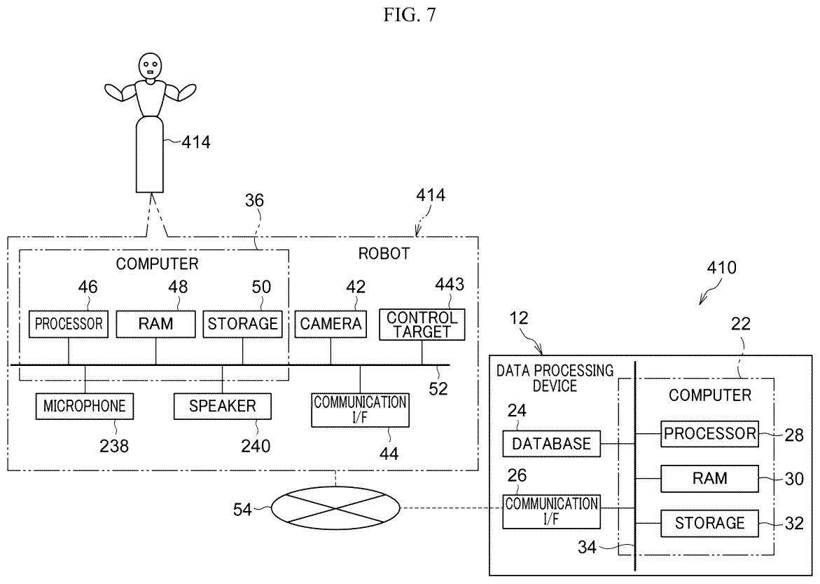

FIG. 7 illustrates an example of a configuration of a data processing system 410 according to a fourth exemplary embodiment

As illustrated in FIG. 7, the data processing system 410 includes a data processing device 12 and a robot 414. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The robot 414 includes a computer 36, a microphone 238, a speaker 240, a camera 42, a communication I/F 44, and a control target 443. The computer 36 includes a processor 46, RAM 48, and storage 50. The processor 46, the RAM 48, and the storage 50 are connected to a bus 52. The microphone 238, the speaker 240, the camera 42, the control target 443, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the robot 414 (for example, with an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

The control target 443 includes a display device, eye LEDs, and motors to drive arms, hands, feet, and the like. The posture and gesture of the robot 414 are controlled by controlling the motors of the arms, hands, feet, and the like. Part of an emotion of the robot 414 can be expressed by controlling these motors. Moreover, a facial expression of the robot 414 can be represented by controlling an illumination state of the eye LEDs of the robot 414.

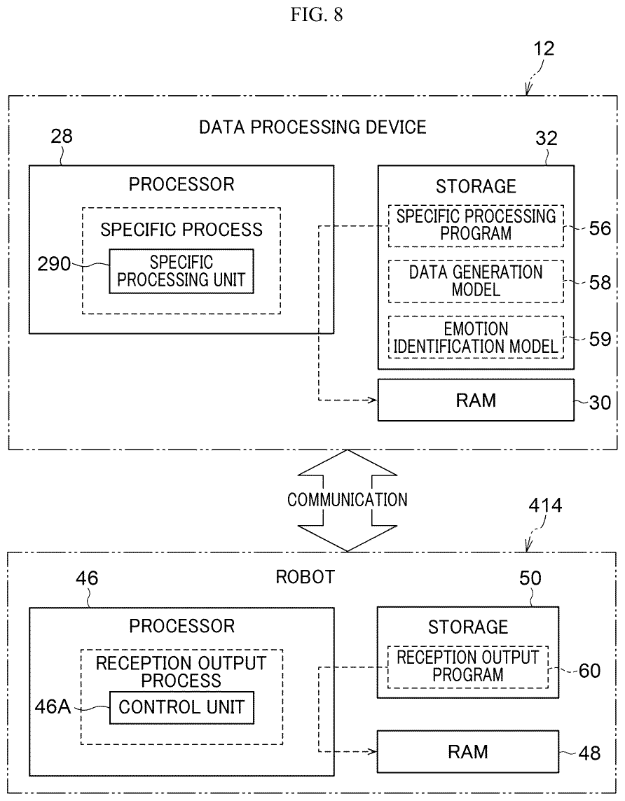

FIG. 8 illustrates an example of relevant functions of the data processing device 12 and the robot 414. As illustrated in FIG. 8, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the robot 414. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the robot 414. In the following description the data processing device 12 is called a “server”, and the robot 414 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the robot 414. In the robot 414, the control unit 46A outputs the result of the specific processing to the speaker 240 and the control target 443. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative Als such as ChatGPT (registered trademark) (Internet search <URL: https://openai.com/blog/chatgpt>) and the like.

The data generation model 58 is obtained by performing deep learning with a neural network.

The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the robot 414, the processing may be executed by a specific processing unit 290 of the data processing device 12 and a control unit 46A of the robot 414. Moreover, the specific processing unit 290 of the data processing device 12 acquires and collects information needed for processing from the robot 414 or from an external device or the like, and the robot 414 acquires and collects information needed for processing from the data processing device 12 or from an external device or the like.

For example, the collection unit is implemented by the control unit 46A of the robot 414 and/or by the specific processing unit 290 of the data processing device 12. For example, an acquisition unit acquires number-of-steps data using the camera 42 and/or the communication I/F 44 of the robot 414, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the control target 443 of the robot 414 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the robot 414.

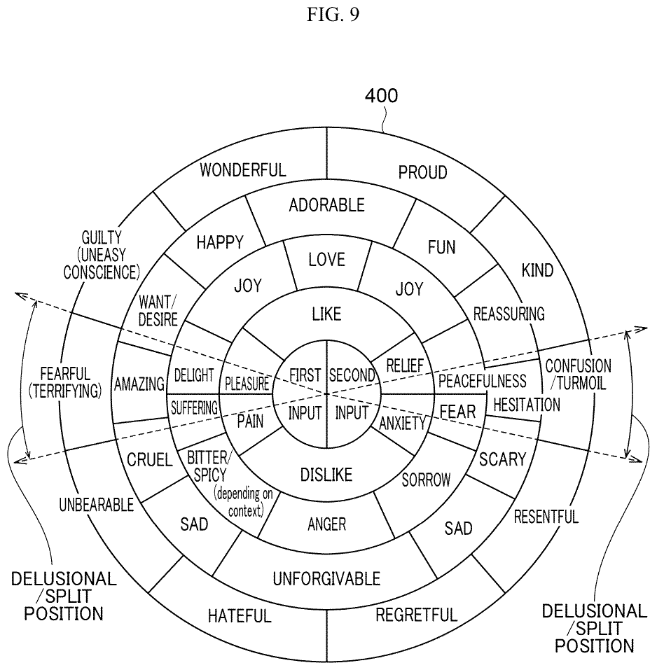

Note that the emotion identification model 59 serves as an emotion engine, and may decide the emotion of a user according to a specific mapping. Specifically, the emotion identification model 59 may decide the emotion of a user according to an emotion map (see FIG. 9) that is a specific mapping. Moreover, the emotion identification model 59 may also decide the emotion of the robot similarly, and the specific processing unit 290 may be configured so as to perform the specific processing using the emotion of the robot.

FIG. 9 is a diagram illustrating an emotion map 400 mapping plural emotions. In the emotion map 400, emotions are arranged in concentric circles that radiate out from the center. Primitive states of emotion are arranged nearer to the center of the concentric circles. Emotions expressing states and actions generated from states of mind are arranged further toward the outside of the concentric circles. Emotions are defined as including both affect and mental states. Emotions generated from reactions occurring in the brain are generally arranged at the left side of the concentric circles. Emotions induced by situational assessment are generally arranged at the right side of the concentric circles. Emotions generated from reactions occurring in the brain that are also emotions induced by situational assessment are generally arranged toward the top and toward the bottom of the concentric circles. Moreover, emotions of “euphoria” are arranged at the upper side of the concentric circles, and emotions of “dysphoria” are arranged at the lower side of the concentric circles. Plural emotions are accordingly mapped in this manner in the emotion map 400 based on a structure giving rise to emotions, and emotions that readily occur at the same time are mapped close to each other.

An example of such emotions is a distribution of emotions in the direction of 3 o'clock on the emotion map 400, generally around a boundary between relief and anxiety. Situational awareness dominates over internal sensations in the right half of the emotion map 400, with an impression of calm.

The inside of the emotion map 400 represents feelings, and the outside of the emotion map 400 represents actions, and so emotions further toward the outside of the emotion map 400 are more visible (are expressed by actions).

Human emotions are based on various balances, such as posture and blood sugar value balances, with a state of dysphoria being exhibited when these balances are far from ideal and a state of euphoria being exhibited when these balances are near to ideal. Even in a robot, a car, a motorbike, or the like, emotions can be thought of as being based on various balances such as orientation and remaining battery balances, with a state called dysphoria being exhibited when these balances are far from ideal and a state called euphoria being exhibited when these balances are near to ideal. An emotion map may, for example, be generated based on the emotion map of Dr. Mitsuyoshi (PhD Dissertation https://ci.nii.ac.jp/naid/500000375379: “Research on the phonetic recognition of feelings and a system for emotional physiological brain signal analysis”, Tokushima University). Emotions belonging to an area called “reaction” where feeling dominates are arranged in the left half of the emotion map. Moreover, emotions belonging to an area called “situation” where situational awareness dominates are arranged in the right half of the emotion map.

There are two types of emotion that facilitate leaning in an emotion map. One is an emotion in the vicinity of the center of negative “penitence” and “reflection” on the situational side. In other words, sometimes a negative “emotion” such as “I don't want to feel this way ever again” and “I don't want to be chided again” is experienced in a robot. Another is a positive emotion in the area of “desire” on the reaction side. In other words, there are times when a positive feeling such as “desire more” and “want to know more” is experienced.

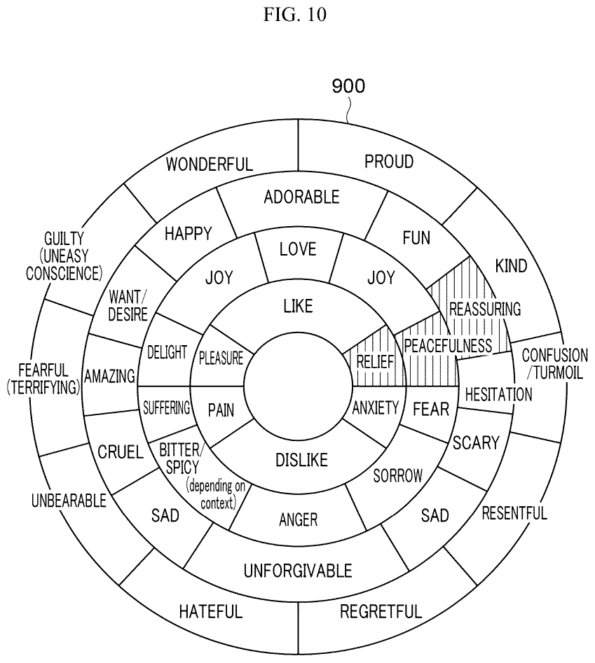

In the emotion identification model 59, user input is input to a pre-trained neural network, and emotion values indicating emotions shown on the emotion map 400 are acquired and the emotions of the user are decided. This neural network is pre-trained based on plural training data sets that each combine a user input with an emotion value indicating an emotion shown on the emotion map 400. The neural network is also trained such that emotions arranged close to each other have values that are close to each other, as in an emotion map 900 illustrated in FIG. 10. In FIG. 10 the plural emotions of “relief”, “peaceful”, and “reassured” are indicated as an example of close emotion values.

Although the system according to the present disclosure has been described mainly as functions of the data processing device 12, the system according to the present disclosure is not limited to being implemented in a server. The system according to the present disclosure may be implemented as a general information processing system. The present disclosure may, for example, be implemented by a software program operating on a personal computer, and may be implemented by an application operating on a smartphone or the like. The method according to the present disclosure may also be supplied to a user in the form of Software as a Service (Saas).

Although in the exemplary embodiments described above examples are given of embodiments in which the specific processing is performed by a single computer 22, technology disclosed herein is not limited thereto, and distributed processing may be performed for the specific processing, with the specific processing distributed across plural computers including the computer 22. For example, the data generation model 58 may be provided in a device external to the data processing device 12, such that data generation in response to input data is performed in the external device.

Although in the exemplary embodiments described above examples are described of embodiments in which the specific processing program 56 is stored in the storage 32, the technology disclosed herein is not limited thereto. For example, the specific processing program 56 may be stored on a portable, non-transitory, computer readable, storage medium, such as universal serial bus (USB) memory or the like. The specific processing program 56 stored on the non-transitory storage medium is then installed on the computer 22 of the data processing device 12. The processor 28 then executes the specific processing according to the specific processing program 56.

Moreover, the specific processing program 56 may be stored on a storage device, such as a server connected to the data processing device 12 over the network 54, with the specific processing program 56 then being downloaded in response to a request from the data processing device 12 and installed on the computer 22.

Note that there is no need to store the entire specific processing program 56 on the storage device, such as a server connected to the data processing device 12 over the network 54, or to store the entire specific processing program 56 on the storage 32, and part of the specific processing program 56 may be stored thereon.

Hardware resources for executing the specific processing may use various processors as listed below. Examples of processors include, for example, a CPU that is a general-purpose processor that functions as a hardware resource to execute the specific processing by executing software, namely a program. Moreover, the processor may, for example, be a dedicated electronic circuit that is a processor having a circuit configuration custom designed for executing the specific processing, such as a field-programmable gate array (FPGA), a programmable logic device (PLD), or an application specific integrated circuit (ASIC). Memory is inbuilt or connected to each of these processors, and the specific processing is executed by each of these processors using the memory.

The hardware resource that executes the specific processing may be configured from one of these various processors, or may be configured from a combination of two or more processors of the same or different type (for example, a combination of plural FPGAs, or a combination of a CPU and a FPGA). The hardware resource executing the specific processing may be a single processor.

Examples of configurations of a single processor include, firstly, a configuration of a single processor resulting from combining one or more CPU and software, in an embodiment in which this processor functions as the hardware resource for executing the specific processing. Secondly, as typified by a System-on-chip (SOC) or the like, there is also an embodiment that uses a processor realized by a single IC chip to function as an overall system including plural hardware resources for executing the specific processing. Adopting such an approach means that the specific processing is realized using one or more of the various processors described above as hardware resource.

Furthermore, more specifically, an electrical circuit that combines circuit elements such as semiconductor elements or the like may be employed as a hardware structure of these various processors. The specific processing is merely an example thereof. This means that obviously redundant steps may be omitted, new steps may be added, and the processing sequence may be swapped around within a range not departing from the spirit of the present disclosure.

The described content and drawing content illustrated above are a detailed description of parts according to the present disclosure, and are merely examples of the present disclosure. For example, description related to the above configuration, function, operation, and advantageous effects is a description related to examples of the configuration, function, operation, and advantageous effects of parts according to the present disclosure. This means that obviously redundant parts may be eliminated, new elements may be added, and switching around may be performed on the described content and drawing content illustrated above within a range not departing from the spirit of the present disclosure. Moreover, to avoid misunderstanding and to facilitate understanding of parts according to the present disclosure, description related to common knowledge in the art and the like not particularly needing description to enable implementation of the present disclosure is omitted in the described content and drawing content illustrated as described above.

All publications, patent applications and technical standards mentioned in the present specification are incorporated by reference in the present specification to the same extent as if each individual publication, patent application, or technical standard was specifically and individually indicated to be incorporated by reference.

Note that, regarding the above description, the following supplementary notes are further disclosed.

### Example 1

### (Supplementary 1)

A system comprising a processor,
wherein the processor is configured to
acquire, via a communication network, event information associated with locations and times from an external information source, structure the event information into tabular data, and perform missing-value correction and time normalization on the tabular data,
convert type information and time information included in the tabular data into numerical features, execute clustering processing based on a machine learning technique using the numerical features, extract, from results of the clustering processing, high-risk regions and high-risk time bands indicating event occurrence tendencies in specific regions and specific time bands, and calculate an index value for each of the high-risk regions,
obtain a map image from a geographic information providing service on the basis of position information of the high-risk regions, and generate display data by assigning visual attributes corresponding to the index value to the high-risk regions on the map image,
display the high-risk regions on the map image in an interactive manner on the basis of the display data, and, in response to a position designation operation from a user, present detailed information corresponding to a high-risk region designated by the position designation operation,
acquire, in response to the position designation operation, ground images or aerial images from a visual information providing service using coordinate information corresponding to the designated high-risk region, and present the ground images or the aerial images in association with the map image,
aggregate event occurrence frequencies for each time band on the basis of the tabular data and the results of the clustering processing, specify, as the high-risk time bands, time bands in which the event occurrence frequencies exceed a predetermined threshold, and manage an association between each of the high-risk regions and the high-risk time bands,
accept a prompt sentence in a natural language including a condition input by the user, and
generate query data by combining the prompt sentence with structured data relating to the high-risk regions and the high-risk time bands, and input the query data to a generative information processing model, and
obtain response information in a natural language output from the generative information processing model, associate a description relating to a region or a route included in the response information with the high-risk regions, and reflect a result of the association in display control on the map image.

### (Supplementary 2)

The system according to supplementary 1,
wherein the processor is configured to
calculate route candidates by a route search technique, using as input position information of a departure point and a destination point, on the basis of the high-risk regions and the high-risk time bands so as to avoid the high-risk regions, input, to the generative information processing model, a prompt sentence including a request for explanation of the route candidates, and, based on response information obtained from the generative information processing model, emphasize, on the map image, a route having higher safety among the route candidates.

### (Supplementary 3)

The system according to supplementary 1,
wherein the processor is configured to
generate countermeasure item candidates with priority assigned for each of the high-risk regions and the high-risk time bands, input, to the generative information processing model, a prompt sentence relating to planning of countermeasures on a regional basis together with the countermeasure item candidates, extract, based on response information obtained from the generative information processing model, countermeasure contents to be implemented in a region, and display, on the map image, the countermeasure contents in association with each of the high-risk regions.

### Application Example 1

### (Supplementary 1)

A system comprising a processor,
wherein the processor is configured to
acquire event information including location information from a plurality of information sources and integrate the event information into standardized data including time information and location information,
convert address information or area information included in the standardized data into position coordinates and associate the position coordinates with predetermined spatial units or area units,
calculate, for each of the spatial units or area units, feature values including event occurrence frequency, event type, time-of-day band of occurrence, and reporting density, and calculate a risk index of each of the spatial units or area units by performing statistical processing or machine learning processing on the feature values,
acquire road network information and area shape information from a geospatial information service and generate geospatial risk data by associating the risk index with the road network information and the area shape information,
generate map display data based on the geospatial risk data and display roads or areas in a differentiated manner according to the risk index,
acquire visual information, from a visual information providing service or an imaging device, associated with areas in the geospatial risk data whose risk index is equal to or greater than a predetermined value, and store the visual information in association with area information and the risk index,
execute a route search process using the road network information and the geospatial risk data based on current position information and destination information acquired from a terminal device, and calculate route candidates that take into account distance or time and the risk index by weighting costs of route elements according to the risk index,
select, from among the route candidates, a route whose safety based on the risk index satisfies a predetermined condition as a safe route, and generate route information including reference information for the visual information corresponding to high-risk areas included in the safe route,
generate an explanation request sentence including the safe route and summary information of the geospatial risk data as a prompt sentence, and input the prompt sentence to a generative AI model, and
acquire, from the generative AI model, explanation information in natural language including a reason for selection of the safe route, an explanation of high-risk areas, and time bands to be avoided, and provide the explanation information in association with the route information in a format outputtable to the terminal device.

### (Supplementary 2)

The system according to supplementary 1,
wherein the processor is configured to dynamically change weighting of the risk index in the route search process based on conditions or priorities related to safety received from a user via the terminal device, and to include the conditions or priorities of the user in the prompt sentence to be input to the generative AI model, thereby acquiring, from the generative AI model, an individualized explanation of the safe route or a proposal of an alternative route for the user.

### (Supplementary 3)

The system according to supplementary 1,
wherein the processor is configured to structure, in natural language, causes of risk,
occurrence tendencies, and countermeasure proposals estimated to be effective for each predetermined area based on the geospatial risk data and the explanation information acquired from the generative AI model, and to clarify countermeasures to be implemented collectively in the area.

### Example 2

### (Supplementary 1)

A system comprising a processor,
wherein the processor is configured to
acquire position information of a user and destination information of the user from a terminal device, and receive input information including a natural language request regarding a safe route,
acquire spatiotemporal information including crime occurrence records from an external information source, normalize the spatiotemporal information, and store the normalized information as record information in a storage device,
analyze the record information by performing statistical processing and machine learning processing to extract crime occurrence tendencies and identify locations and time periods in which crimes are likely to occur,
acquire geospatial information, map the locations in which crimes are likely to occur onto the geospatial information as area information, and calculate a risk index for each path element, perform, based on the area information and the risk index, weighting on components of a movement route according to a risk level, and calculate a plurality of candidate routes by route search processing,
generate a prompt sentence including structured information relating to the plurality of candidate routes and the risk index, and input the prompt sentence to a generative artificial intelligence model,
obtain, from the generative artificial intelligence model, evaluation information relating to the plurality of candidate routes and identification information of a recommended route determined in consideration of safety and movement efficiency,
generate, based on the identification information of the recommended route and the evaluation information, route information of a selected safe route and explanation information including reasons why the route is determined to be safe, and output the route information in a format displayable on the geospatial information,
acquire, after movement along the safe route, evaluation information relating to safety of the route and free-form description information from the user, and store the evaluation information and the free-form description information in association with the record information and the risk index in the storage device, and
analyze the stored evaluation information and the free-form description information by natural language processing, generate a prompt sentence including an analysis result, input the prompt sentence to the generative artificial intelligence model to obtain update rules of the risk index, and update the risk index for each path element based on the update rules.

### (Supplementary 2)

The system according to supplementary 1,
wherein the processor is configured to
generate the explanation information obtained from the generative artificial intelligence model as guidance information in a natural language format to be presented to the user, and
output the guidance information as visual guidance and voice guidance via the terminal device.

### (Supplementary 3)

The system according to supplementary 1,
wherein the processor is configured to
generate, based on the locations in which crimes are likely to occur and the evaluation information and the free-form description information from the user, a prompt sentence for generating structured information including proposals of regional safety measures, input the prompt sentence to the generative artificial intelligence model, obtain the proposals of the regional safety measures from the generative artificial intelligence model, and output the proposals as guideline information for planning measures in a region.

### Application Example 2

### (Supplementary 1)

A system comprising a processor and a communication interface,
wherein the processor is configured to
acquire, via the communication interface, location information and user input information from a user terminal,
acquire, on the basis of the location information, a plurality of movement route candidates including a departure point and an arrival point,
acquire, from an external information source, event information relating to an area including the movement route candidates,
aggregate the event information in association with the movement route candidates and calculate, for each of the movement route candidates, an evaluation value indicating a safety level of the corresponding movement route candidate,
analyze emotion-related information included in the user input information to specify an emotional state of a user,
change calculation conditions of the evaluation value in accordance with the emotional state and re-evaluate the movement route candidates so as to specify a recommended route,
generate context information including the recommended route, the event information, and
the emotional state as explanation information, and generate a prompt sentence to be input to
a generative AI model on the basis of the context information,
input the prompt sentence to the generative AI model and acquire response information from the generative AI model, and
provide the recommended route and the response information to the user terminal.

### (Supplementary 2)

The system according to supplementary 1,
wherein the processor is configured to
present the recommended route as a safe movement route on the basis of the evaluation value, successively acquire the location information during movement of the user, detect a deviation from the recommended route, recalculate the recommended route on the basis of the event information and the emotional state, generate an update prompt sentence relating to the recalculated recommended route, acquire update response information from the generative AI model, and present the recalculated recommended route together with the update response information to the user terminal.

### (Supplementary 3)

The system according to supplementary 1,
wherein the processor is configured to
aggregate the event information and the emotion-related information for each of a plurality of regions and time periods, calculate a safety index for each region on the basis of an aggregation result, generate analysis context information including candidate countermeasures for crime prevention, generate a prompt sentence to be input to the generative AI model on the basis of the analysis context information, acquire response information from the generative AI model, and present countermeasure contents for the region on the basis of the response information.

What is claimed is:

1. A system comprising:
circuitry configured to
acquire, via a packet-switched network, event record data associated with geographic coordinate values and timestamp values from at least one external data source, and structure the event record data into tabular data records with normalized temporal fields,
convert category information and temporal information included in the tabular data records into numerical feature vectors, execute clustering processing on the numerical feature vectors using a machine learning model, extract elevated-index regions and elevated-index temporal bands from a result of the clustering processing, and compute an index value for each elevated-index region,
obtain map image data from a geographic information service based on position data of the elevated-index regions and generate display data by assigning visual attribute values corresponding to the index value to representations of the elevated-index regions on the map image data,
accept, via the packet-switched network, a natural language input from a terminal device, generate a structured input sequence for a generative neural network model by combining the natural language input with structured data derived from the elevated-index regions and the elevated-index temporal bands, and acquire response data from the generative neural network model, and
transmit, via the packet-switched network, the response data together with the display data to the terminal device for rendering on a display of the terminal device.

2. The system according to claim 1, wherein the circuitry is further configured to:
aggregate event occurrence frequency values for each temporal band based on the tabular data records and the result of the clustering processing,
designate, as the elevated-index temporal bands, temporal bands in which the event occurrence frequency values exceed a predetermined threshold, and
store an association between each elevated-index region and its corresponding elevated-index temporal bands in the data repository.

3. The system according to claim 2, wherein the circuitry is further configured to:
calculate a plurality of path candidates between a departure coordinate and a destination coordinate using a path computation algorithm,
evaluate each path candidate based on proximity to the elevated-index regions and the elevated-index temporal bands, and
select a path candidate having a lowest aggregate proximity score as an optimized path datum included in the response data.

4. The system according to claim 3, wherein the circuitry includes the optimized path datum and the associated index values in the structured input sequence for the generative neural network model, and wherein the generative neural network model generates a natural language explanation describing characteristics of the optimized path datum relative to the elevated-index regions.

5. The system according to claim 4, wherein the optimized path datum comprises a safe route proposal that avoids geographic areas classified as high-risk crime regions during time periods classified as high-risk time bands, and wherein the natural language explanation includes safety guidance generated by the generative neural network model.

6. The system according to claim 1, wherein the circuitry is further configured to:
acquire, from a visual information service via the packet-switched network, at least one of ground-level image data and aerial image data corresponding to coordinate values of a designated elevated-index region, and
transmit the at least one of the ground-level image data and the aerial image data to the terminal device for rendering in association with the map image data.

7. The system according to claim 6, wherein the circuitry is further configured to:
apply an image analysis model to the at least one of the ground-level image data and the aerial image data to extract environmental feature descriptors, and
include the environmental feature descriptors in the structured input sequence for the generative neural network model.

8. The system according to claim 1, wherein the clustering processing comprises a density-based or centroid-based clustering algorithm that partitions the numerical feature vectors into a plurality of clusters, and wherein the circuitry assigns a cluster label to each tabular data record and identifies clusters having event density values exceeding a density threshold as the elevated-index regions.

9. The system according to claim 8, wherein the numerical feature vectors comprise encoded category values derived from event type labels via one-hot encoding or embedding transformation, and normalized temporal values derived from the timestamp values via min-max normalization or z-score normalization.

10. The system according to claim 1, wherein the display data comprises interactive map elements that respond to a position designation operation from the terminal device, and wherein the circuitry, in response to receiving the position designation operation, retrieves detailed information corresponding to a designated elevated-index region and transmits the detailed information to the terminal device.

11. The system according to claim 10, wherein the visual attribute values comprise at least one of a color gradient value, an icon size value, and an opacity value that vary proportionally with the index value of each elevated-index region.

12. The system according to claim 1, wherein the generative neural network model is a transformer-based language model comprising a plurality of self-attention layers, and wherein the circuitry encodes the structured input sequence into token identifiers processed through the plurality of self-attention layers to produce the response data.

13. The system according to claim 1, wherein the circuitry is further configured to:
generate mitigation action data based on the response data from the generative neural network model, the mitigation action data comprising recommended regional measures associated with specific elevated-index regions, and
transmit the mitigation action data to the terminal device for rendering in association with the map image data.

14. The system according to claim 13, wherein the mitigation action data comprises countermeasure proposals for reducing incident occurrence in high-risk regions, generated by the generative neural network model based on event pattern characteristics, environmental feature descriptors, and temporal distribution data included in the structured input sequence.

15. The system according to claim 1, wherein the circuitry is further configured to:
apply an affective state classifier to text input data received from the terminal device to determine an affective state label of a user, and
incorporate the affective state label into the structured input sequence for the generative neural network model.

16. The system according to claim 1, wherein the circuitry is further configured to:
receive, via the packet-switched network, image frame data from an image acquisition device of the terminal device,
apply a convolutional neural network-based expression classification model to the image frame data to determine an expression label, and
incorporate the expression label into the structured input sequence for the generative neural network model.

17. The system according to claim 1, wherein the circuitry is further configured to:
periodically re-acquire the event record data from the at least one external data source,
re-execute the clustering processing on updated tabular data records, and
update the index values and the display data to reflect changes in the elevated-index regions and the elevated-index temporal bands.

18. A system comprising:
circuitry configured to
acquire, via a packet-switched network, event record data from at least one external data source,
convert the event record data into numerical feature vectors and execute clustering processing to extract elevated-index regions and elevated-index temporal bands,
obtain map image data and generate display data with visual attribute values for the elevated-index regions,
acquire visual information data corresponding to coordinates of a designated elevated-index region,
calculate path candidates and evaluate each path candidate based on proximity to the elevated-index regions,
generate a structured input sequence for a generative neural network model by combining a natural language input with structured data derived from the elevated-index regions, the elevated-index temporal bands, and the path candidates,
acquire response data from the generative neural network model, and
transmit, via the packet-switched network, the response data and the display data to a terminal device.

19. The system according to claim 18, wherein the circuitry is further configured to:
associate descriptions included in the response data with specific elevated-index regions on the map image data, and
generate mitigation action data comprising recommended measures for each elevated-index region based on the response data.

20. A method performed by a system comprising circuitry, the method comprising:
acquiring, via a packet-switched network, event record data associated with geographic coordinate values and timestamp values from at least one external data source, and structuring the event record data into tabular data records with normalized temporal fields;
converting category information and temporal information included in the tabular data records into numerical feature vectors, executing clustering processing on the numerical feature vectors using a machine learning model, extracting elevated-index regions and elevated-index temporal bands from a result of the clustering processing, and computing an index value for each elevated-index region;
obtaining map image data from a geographic information service and generating display data by assigning visual attribute values corresponding to the index value to representations of the elevated-index regions on the map image data;
generating a structured input sequence for a generative neural network model by combining a natural language input with structured data derived from the elevated-index regions and the elevated-index temporal bands, and acquiring response data from the generative neural network model; and
transmitting, via the packet-switched network, the response data together with the display data to a terminal device for rendering on a display of the terminal device.
